(19) United States
(12) Patent Application Publication
(10) Pub. No.: US 2013/0195058 A1
(43) Pub. Date: Aug. 1, 2013

(54) APPARATUS, SYSTEM AND METHOD FOR WIRELESS COMMUNICATION

(71) Applicant: FUJITSU LIMITED, Kawasaki-shi (JP)

(72) Inventor: Takayoshi ODE, Yokohama (JP)

(73) Assignee: FUJITSU LIMITED, Kawasaki-shi (JP)

(21) Appl. No.: 13/795,039

(22) Filed: Mar. 12, 2013

Related U.S. Application Data
(63) Continuation of application No. PCT/JP2010/067025, filed on Sep. 30, 2010.

(51) Int. Cl. H04W 72/04

(52) U.S. Cl. CPC H04W 72/048
USPC 370/329; 370/328

(57) ABSTRACT

A wireless communication apparatus communicates with another wireless communication apparatus, using multiple frequency bands. A notifying unit notifies the other wireless communication apparatus of capability information on capability of the wireless communication apparatus to handle in parallel first-length guard intervals and second-length guard intervals. A transmitting unit transmits first data with the first-length guard intervals in a first frequency band and transmits second data with the second-length guard intervals in a second frequency band. A control unit schedules transmission of at least one of the first data and the second data based on the capability information.

### CROSS-REFERENCE TO RELATED APPLICATION

This application is a continuation application of International Application PCT/JP2010/067025 filed on Sep. 30, 2010 and designated the U.S., the entire contents of which are herein wholly incorporated by reference.

### FIELD

The embodiments discussed herein are related to a wireless communication apparatus, a wireless communication system, and a wireless communication method.

### BACKGROUND

Currently, wireless communication systems such as mobile phone systems and wireless Local Area Networks (LAN) are used widely. In addition, active discussions on next generation wireless communication technology have been continued in order to further increase the speed and capacity of wireless communication.

For example, the 3rd Generation Partnership Project (3GPP), which is a standards organization, has proposed a communication standard called Long Term Evolution (LTE) which allows wireless communication using a frequency band up to 20 MHz. Further, a communication standard called Long Term Evolution-Advanced (LTE-A) which allows wireless communication using up to five 20-MHz carriers (that is, 100 MHz) has been proposed as a next generation communication standard after the LTE standard.

In LTE and LTE-A, a data transmission scheme called Multimedia Broadcast multicast service Single Frequency Network (MBSFN) has been examined. In MBSFN operation, multiple base stations concurrently transmit data of the same content using the same frequency and the same modulation scheme. Data transmitted using MBSFN is referred to, for example, as the “Multimedia Broadcast Multicast Service (MBMS) data”. A mobile station combines wireless signals transmitted from multiple base stations, which leads to an improvement in received quality of the MBMS data.

As for LTE and LTE-A wireless signals, a guard interval (commonly referred to as the “cyclic prefix (CP)” in LTE and LTE-A) is inserted between two useful symbols, which are data signals, in order to reduce intersymbol interference caused by multipath delayed waves. A longer guard interval provides increased immunity to the effect of delay waves with a large delay time. MBSFN transmission employs guard intervals of longer length than those used in transmission of dedicated data directed to a particular mobile station so that mobile stations are able to combine wireless signals transmitted from a larger number of base stations (even from base stations located farther away).

A wireless communication system has been proposed in which, in a condition where multiple kinds of wireless terminals each of which has a different transmission and reception frequency bandwidth exist within the coverage of a base station, each wireless terminal notifies the base station of its transmission and reception frequency bandwidth and, then, the base station selects a sub-band to be used for communication with the wireless terminal according to the notification (see, for example, paragraph [0047] of Japanese Laid-open Patent Publication No. 2010-41581). Another proposed technology is directed to a base station using MBSFN, which frequency-division multiplexes unicast data with shorter cyclic prefixes appended and MBMS data with longer cyclic prefixes appended, with a guardband provided therebetween (see, for example, paragraph [0040] of Japanese Laid-open Patent Publication No. 2009-267988).

A transmission apparatus has been proposed that time-multiplexes a unicast channel and an MBMS channel with guard intervals of different lengths in the same frequency band and transmits the time-multiplexed transmission symbol (see, for example, Japanese Laid-open Patent Publication No. 2010-81652). Another proposed transmitter is configured to set a group of wireless parameters in such a manner that the ratio of a guard interval part within one symbol duration becomes constant in the case where the guard interval length is variable, to thereby maintain constant data transmission efficiency (see, for example, paragraph [0012] of Japanese Laid-open Patent Publication No. 2010-98773).

In a wireless communication system for communicating with the use of multiple frequency bands, data with guard intervals of a first length may be transmitted in a first frequency band while data with guard intervals of a second length are transmitted in a second frequency band. In this case, the data with the first-length guard intervals may be transmitted at the same time as the data with the second-length guard intervals.

However, parallel reception of data with guard intervals of different lengths imposes, upon wireless communication apparatuses receiving the data, a substantial burden associated with reception processes including extraction of useful symbols from received signals and a fast Fourier transform (FFT). Because of this, some wireless communication apparatuses may have limited capability to handle in parallel guard intervals of different lengths. Assume that data with the first-length guard intervals and data with the second-length guard intervals are concurrently transmitted to a wireless communication apparatus incapable of handling in parallel guard intervals of different lengths. In this case, the data transmission may end up being wasteful because the wireless communication apparatus is not able to receive at least one of the data with the first-length guard intervals and the data with the second-length guard intervals.

### SUMMARY

According to one aspect, there is provided a wireless communication apparatus for communicating with another wireless communication apparatus, using multiple frequency bands. The wireless communication apparatus includes a transmitting unit and a control unit. The transmitting unit is configured to transmit first data with first-length guard intervals in a first frequency band selected from among the multiple frequency bands, and transmit second data with second-length guard intervals in a second frequency band selected from among the multiple frequency bands. The control unit is configured to acquire, from the other wireless communication apparatus, capability information on the capability of the other wireless communication apparatus to handle in parallel the first-length guard intervals and the second-length guard intervals, and schedule transmission of at least one of the first data and the second data based on the capability information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a wireless communication system according to a first embodiment;

FIG. 2 illustrates a mobile communication system according to a second embodiment;

FIG. 3 illustrates a configuration example of component carriers;

FIG. 4 illustrates a first example of carrier aggregation;

FIG. 5 illustrates a second example of the carrier aggregation;

FIG. 6 illustrates a configuration example of an MBSFN area;

FIG. 7 illustrates an example of transmission of dedicated data and MBMS data;

FIG. 8 illustrates a structural example of a wireless frame;

FIG. 9 illustrates a structural example of a symbol;

FIG. 10 illustrates a method for combining MBMS data signals;

FIG. 11 illustrates a configuration example of normal subframes and an MBSFN subframe;

FIG. 12 is a table illustrating a first category example of mobile stations;

FIG. 13 is a table illustrating a second category example of mobile stations;

FIG. 14 is a block diagram of a base station according to the second embodiment;

FIG. 15 is a block diagram of an apparatus control unit of the base station;

FIG. 16 is a block diagram of a mobile station according to the second embodiment;

FIG. 17 is a block diagram of a terminal control unit of the mobile station;

FIG. 18 is a block diagram of a first example of a reception circuit of the mobile station;

FIG. 19 is a block diagram of a second example of the reception circuit of the mobile station;

FIG. 20 is a block diagram of a third example of the reception circuit of the mobile station;

FIG. 21 is a block diagram of a Multi-cell/multicast Coordination Entity (MCE) according to the second embodiment;

FIG. 22 is a flowchart illustrating a transmission process of the base station;

FIG. 23 is a flowchart illustrating a reception process of the mobile station;

FIG. 24 is a first sequence diagram illustrating an example of data transmission control;

FIG. 25 is a second sequence diagram illustrating an example of data transmission control;

FIG. 26 is a third sequence diagram illustrating an example of data transmission control;

FIG. 27 is a fourth sequence diagram illustrating an example of data transmission control;

FIG. 28 is a block diagram of a base station according to a third embodiment;

FIG. 29 is a block diagram of an MCE according to the third embodiment; and

FIG. 30 is a fifth sequence diagram illustrating an example of data transmission control.

### DESCRIPTION OF EMBODIMENTS

Several embodiments will be described below with reference to the accompanying drawings, wherein like reference numerals refer to like elements throughout.

### First Embodiment

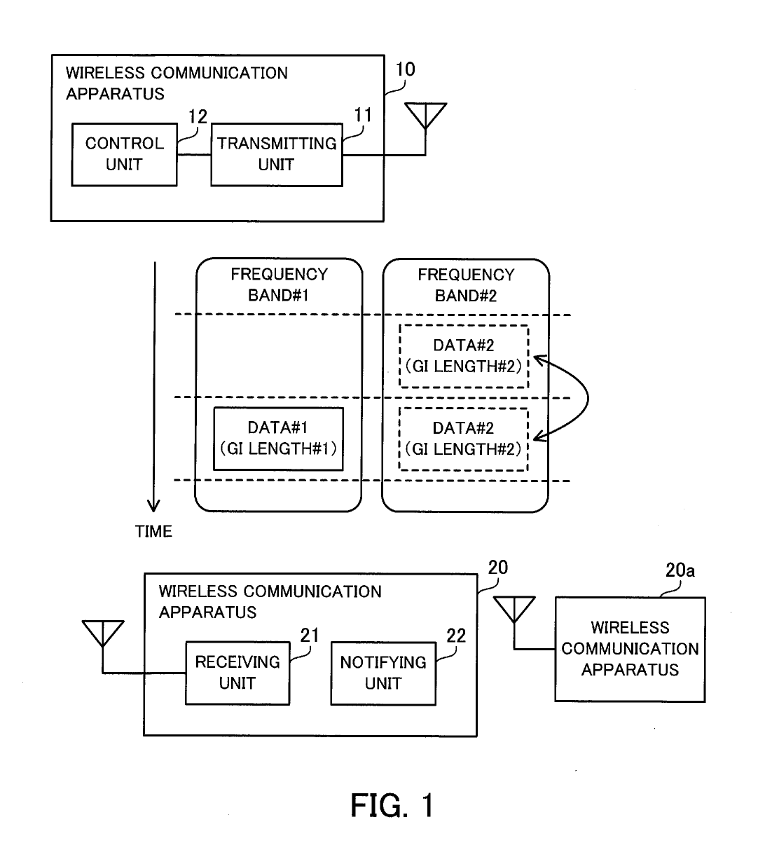

FIG. 1 illustrates a wireless communication system according to a first embodiment. The wireless communication system of the first embodiment includes wireless communication apparatuses 10, 20, and 20a. The wireless communication apparatus 10 and the wireless communication apparatuses 20 and 20a communicate with each other wirelessly using multiple frequency bands including frequency bands #1 and #2. Assume here that the wireless communication apparatus 10 is a base station and the wireless communication apparatuses 20 and 20a are mobile stations.

The wireless communication apparatus 10 includes a transmitting unit 11 and a control unit 12. The transmitting unit 11 transmits data #1 in frequency band #1 and transmits data #2 in frequency band #2. Data #1 is transmitted with guard intervals (GI in FIG. 1) of a first length, and is MBMS data, for example, receivable by multiple wireless communication apparatuses including the wireless communication apparatuses 20 and 20a. On the other hand, data #2 is transmitted with guard intervals of a second length, and is dedicated data directed, for example, to the wireless communication apparatus 20 (or the wireless communication apparatus 20a). The control unit 12 schedules transmission of at least one of data #1 and data #2 to be carried out by the transmitting unit 11. For example, the control unit 12 controls a transmission timing of data #2 specifically directed to the wireless communication apparatus 20 (or 20a).

The wireless communication apparatus 20 includes a receiving unit 21 and a notifying unit 22. The receiving unit 21 is configured to receive data #1 transmitted in frequency band #1 and data #2 transmitted in frequency band #2. The receiving unit 21 may or may not be capable of handling in parallel guard intervals of different lengths. For example, the receiving unit 21 may or may not be able to receive in parallel data #1 and data #2 when they are transmitted at the same time. The notifying unit 22 notifies the wireless communication apparatus 10 of capability information on the capability of the receiving unit 21 to handle in parallel guard intervals of different lengths. The wireless communication apparatus 20a also includes a receiving unit and a notifying unit, as in the case of the wireless communication apparatus 20.

Based on the capability information notified of by the wireless communication apparatus 20/20a, the control unit 12 schedules transmission of at least one of data #1 and data #2. In the case where the wireless communication apparatus 20 is capable of handling in parallel guard intervals of different lengths, the control unit 12 may schedule data #2, which is dedicated data directed to the wireless communication apparatus 20, to be transmitted at the same time as data #1. On the other hand, if the wireless communication apparatus 20a is not capable of handling in parallel guard intervals of different lengths, the control unit 12 tries to schedule data #2, which is dedicated data directed to the wireless communication apparatus 20a, to be transmitted at a different time from data #1.

Note that multiple wireless communication apparatuses including the wireless communication apparatuses 20 and 20a may be classified into multiple categories according to one or more capability-related aspects including the capability of handling in parallel guard intervals of different lengths. In that case, the notifying unit 22 may notify the wireless communication apparatus 10 of information indicating a category of the wireless communication apparatus 20, as the capability information. Such capability information may be provided by the wireless communication apparatus 20/20a to the wireless communication apparatus 10 when the wireless communication apparatus 20/20a establishes a connection to the wireless communication apparatus 10.

According to the wireless communication system of the first embodiment described above, the wireless communication apparatus 20/20a notifies the wireless communication apparatus 10 of the capability information on the capability of handling in parallel guard intervals of the first and second lengths. Based on the capability information, the wireless communication apparatus 10 schedules transmission of at least one of data #1 with the first-length guard intervals and data #2 with the second-length guard intervals. According to the scheduling result, the wireless communication apparatus 10 transmits data #1 in frequency band #1 and data #2 in frequency band #2 concurrently or at different times.

This enables efficient wireless communication using multiple frequency bands including frequency bands #1 and #2. For example, in the case where the wireless communication apparatus 20 is capable of handling in parallel guard intervals of different lengths, the wireless communication apparatus 10 schedules transmission of data #2 directed to the wireless communication apparatus 20 with fewer limitations on the transmission timing. This results in an effective use of wireless resources of frequency bands #1 and #2. On the other hand, if the wireless communication apparatus 20a is not capable of handling in parallel guard intervals of different lengths, the wireless communication apparatus 10 avoids concurrent transmission of data #2 directed to the wireless communication apparatus 20a and data #1 receivable by multiple communication apparatuses. This prevents wasteful data transmission.

Note that the wireless communication system of the first embodiment may be implemented as an LTE-A system. In that case, frequency bands #1 and #2 may be bands called component carriers (CC) or bands called subcarrier blocks, and the guard intervals may be cyclic prefixes (CP). Second and third embodiments described below are directed to examples of an LTE-A mobile communication system.

### Second Embodiment

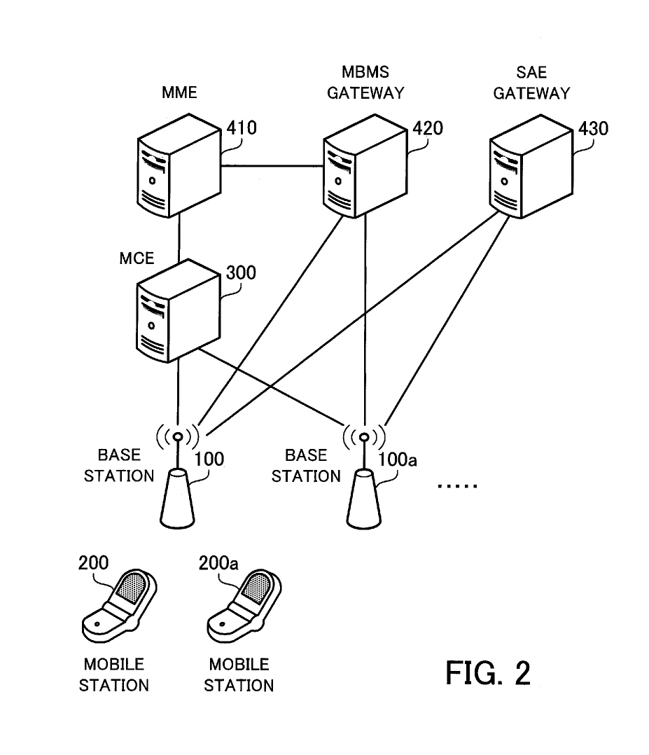

FIG. 2 illustrates a mobile communication system according to a second embodiment. The mobile communication system of the second embodiment includes multiple base stations including base stations 100 and 100a; mobile stations 200 and 200a; a Multi-cell/multicast Coordination Entity (MCE) 300; a Mobility Management Entity (MME) 410; a MBMS gateway 420; and a System Architecture Evolution (SAE) gateway 430.

The base stations 100 and 100a are wireless communication apparatuses capable of individually establishing wireless communication with each of the mobile stations 200 and 200a. For the wireless communication, multiple component carriers (CC) are used. The base station 100/100a is connected to the MCE 300, the MBMS gateway 420, and the SAE gateway 430 via a wired network. The base station 100/100a transfers dedicated data directed to the mobile station 200/200a between the mobile station 200/200a and the SAE gateway 430. In addition, under the control of the MCE 300, the base stations 100 and 100a carry out MBSFN transmission (i.e. concurrent transmission of MBMS data of the same content using the same frequency and the same modulation scheme). The MBMS data is acquired from the MBMS gateway 420.

The mobile stations 200 and 200a are wireless terminals capable of individually establishing wireless communication with each of the base stations 100 and 100a. Mobile telephones and mobile information terminals are examples of the mobile stations 200 and 200a. The mobile station 200/200a receives dedicated data from the base station 100 or 100a in a downlink (DL), and transmits dedicated data to the base station 100 or 100a in an uplink (UL). The second embodiment is directed to a case in which each of the mobile stations 200 and 200a establishes a connection to the base station 100 to thereby transmit and receive dedicated data. In addition, the mobile station 200/200a receives MBMS data sent by MBSFN transmission. The mobile station 200/200a receives signals including MBMS data, concurrently transmitted by multiple base stations including the base stations 100 and 100a, then combines the received signals, and demodulates and decodes the combined signal.

The MCE 300 is a communication apparatus for controlling MBSFN transmission. The MCE 300 receives, from the base station 100/100a, an MBSFN request transmitted from the mobile station 200/200a and schedules MBSFN transmission. Subsequently, the MCE 300 transmits MBSFN control information to the base stations 100 and 100a and instructs the MBMS gateway 420 to transmit MBMS data.

The MME 410 is a communication apparatus for managing the mobility of the mobile stations 200 and 200a. More specifically, the MME 410 communicates with the base stations 100 and 100a and manages serving cells of the mobile stations 200 and 200a. The MBMS gateway 420 is a communication apparatus for processing MBMS data to be sent by MBSFN transmission. The MBMS gateway 420 transmits MBMS data to the base stations 100 and 100a under the control of the MCE 300. The SAE gateway 430 is a communication apparatus for processing dedicated data directed to the mobile station 200/200a. More specifically, the SAE gateway 430 transmits, to the base station 100/100a, dedicated data directed to the mobile station 200/200a and receives, from the base station 100/100a, data transmitted by the mobile station 200/200a.

Note that MBSFN transmission is controlled by the stand-alone MCE 300 according to the second embodiment. However, the function of the MCE 300 may be implemented on the base stations 100 and 100a. In that case, multiple base stations including the base stations 100 and 100a communicate with each other to control MBSFN transmission. Alternatively, the function of the MCE 300 may be implemented on a different communication apparatus within the wired network, such as the MME 410.

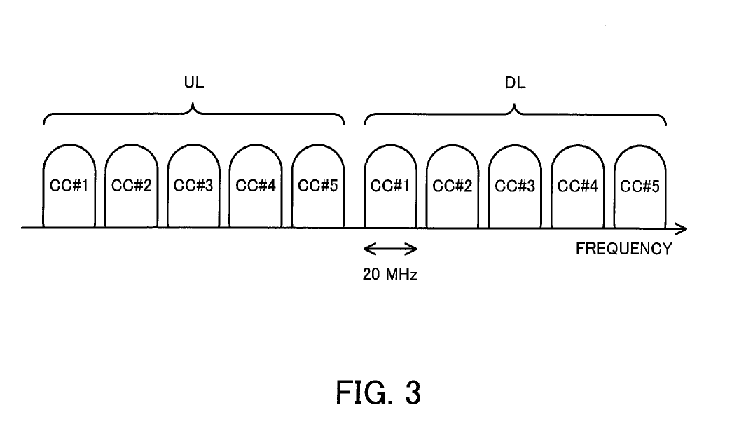

FIG. 3 illustrates a configuration example of component carriers. The base station 100/100a uses up to five component carriers (CCs #1 to #5) for wireless communication. In the case of using Frequency Division Duplex (FDD) for bidirectional communication, frequency bands of CCs #1 to #5 are provided individually for the downlink and the uplink. For the downlink, each of the component carriers has a bandwidth of 20 MHz, providing a total bandwidth of 100 MHz.

The base station 100/100a controls wireless resource allocation for each of CCs #1 to #5. The base stations 100/100a aggregates multiple component carriers for wireless communication with the mobile station 200/200a (i.e., use multiple component carriers at the same time). This enables data communication using a wider bandwidth (for example, 40 MHz, 60 MHz, 80 MHz, or 100 MHz) than the bandwidth of one component carrier (for example, 20 MHz).

Note that, according to the example of FIG. 3, bidirectional communication is achieved using FDD, however, it may be achieved using Time Division Duplex (TDD) instead. In that case, five component carriers are provided on the frequency axis with no separation between the downlink and the uplink. In the description above, each of the component carriers in the downlink has a bandwidth of 20 MHz, however, they may have a different bandwidth (for example, 5 MHz, 10 MHz, or 15 MHz). In addition, not all the component carriers need to have the same bandwidth.

According to the example of FIG. 3, the uplink wireless resources are provided on the lower frequency side and the downlink wireless resources are provided on the higher frequency side. Providing the uplink wireless resources on the lower frequency side keeps the transmission power of the mobile station 200/200a low since a signal of a lower frequency has a smaller propagation loss. Note however that the locations of the uplink wireless resources and the downlink wireless resources on the frequency axis may be switched.

Note here that all CCs #1 to #5 may be provided in a single frequency band, such as an 800 MHz frequency band, a 2.5 GHz frequency band, or a 3.5 GHz frequency band, or may be provided separately in multiple different frequency bands. Aggregating multiple component carriers is sometimes referred to as the “carrier aggregation”. Carrier aggregation of component carriers belonging to different frequency bands is sometimes referred to as the “spectrum aggregation”.

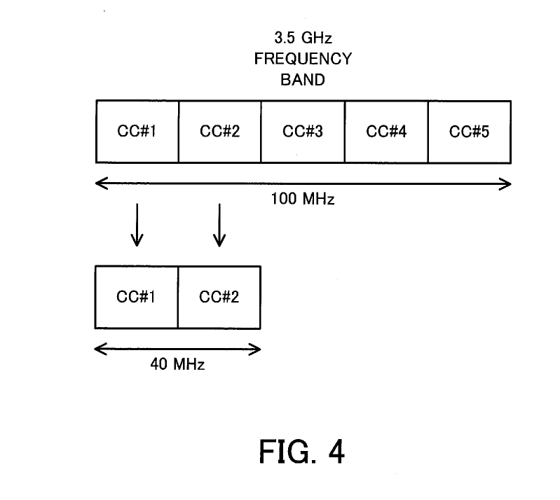

FIG. 4 illustrates a first example of the carrier aggregation. According to the example of FIG. 4, a continuous 100 MHz bandwidth is provided in the 3.5 GHz frequency band as a bandwidth available for wireless communication. The 100 MHz bandwidth is divided into five, which are individually defined as CCs #1 to #5 each having a bandwidth of 20 MHz.

The mobile station 200/200a uses, for example, CCs #1 and #2 as a frequency bandwidth of 40 MHz (logically a single frequency bandwidth) by carrier aggregation. In this case, in reality, the mobile station 200/200a uses a part of the continuous 100 MHz bandwidth provided in the 3.5 GHz frequency band. Although FIG. 4 illustrates an example of a frequency bandwidth belonging to the 3.5 GHz frequency band, carrier aggregation may also be employed in a different frequency band, such as the 800 MHz frequency band and the 2.5 GHz frequency band.

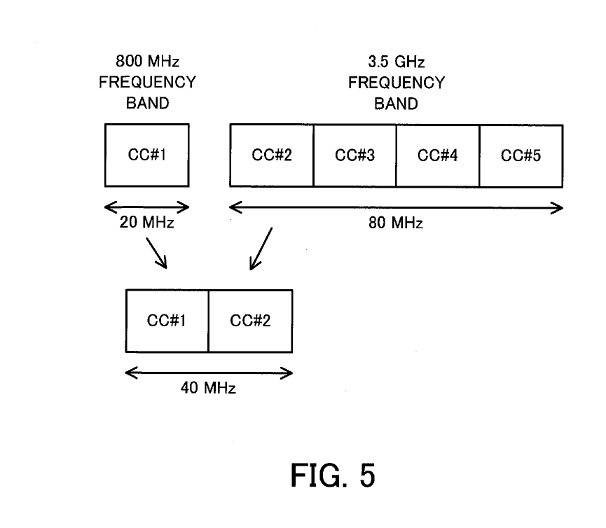

FIG. 5 illustrates a second example of the carrier aggregation. According to the example of FIG. 5, a 20 MHz bandwidth is provided in the 800 MHz frequency band as a bandwidth available for wireless communication. In addition, a continuous 80 MHz bandwidth is provided in the 3.5 GHz frequency band as a bandwidth available for wireless communication. The 20 MHz bandwidth in the 800 MHz frequency band is defined as CC #1, and the 80 MHz bandwidth in the 3.5 GHz frequency band is divided into four, which are individually defined as CCs #2 to #5 each having a bandwidth of 20 MHz.

The mobile station 200/200a use, for example, CCs #1 and #2 as a frequency bandwidth of 40 MHz (logically a single frequency bandwidth) by spectrum aggregation (carrier aggregation). In this case, in reality, the mobile station 200/200a uses the 20 MHz bandwidth belonging to the 800 MHz frequency band and a part of the continuous 80 MHz bandwidth belonging to the 3.5 GHz frequency band. FIG. 5 depicts an example of spectrum aggregation with the combination of the 800 MHz frequency band and the 3.5 GHz frequency band, however, spectrum aggregation may also be employed for a combination of different frequency bands.

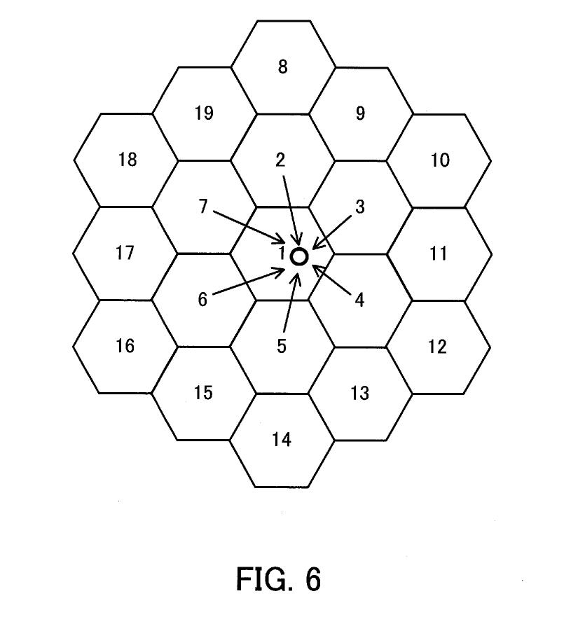

FIG. 6 illustrates a configuration example of an MBSFN area. Within the MBSFN area, MBMS data transmission is synchronized by the control of the MCE 300. The MBSFN area includes 19 cells (cells #1 to #19) according the example of FIG. 6.

Assume here that the mobile station 200 exists in cell #1, and that MBMS data to be received by the mobile station 200 is transmitted from all the cells within the MBSFN area (cells #1 to #19). In this case, the mobile station 200 combines wireless signals of up to 19 cells, and demodulates and decodes the composite signal, to thereby extract the MBMS data. Note however that it is possible to prevent some cells within the MBSFN area from transmitting the MBMS data to be received by the mobile station 200.

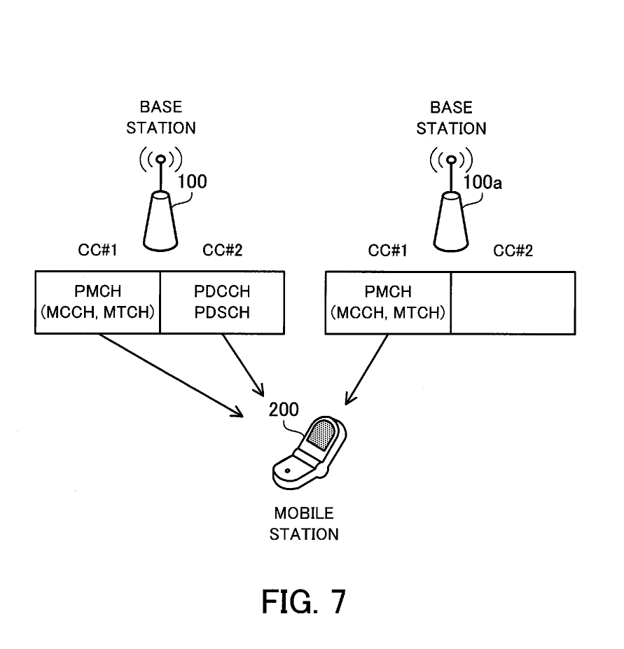

FIG. 7 illustrates an example of transmission of dedicated data and MBMS data. The mobile station 200 is able to receive MBMS data sent by MBSFN transmission, using one component carrier and also receive dedicated data directed to the mobile station 200, using another component carrier. The example of FIG. 7 depicts the case where CCs #1 and #2 are used for wireless communication between the base station 100 and the mobile station 200.

For example, the base station 100 transmits a Physical Multicast Channel (PMCH), which is a physical channel, using CC #1. In the PMCH, a Multicast Control Channel (MCCH) and a Multicast Traffic Channel (MTCH) are mapped. The MCCH is a logical channel for transmitting MBSFN control information, and the MTCH is a logical channel for transmitting MBMS data. In addition, the base station 100 transmits a Physical Downlink Control Channel (PDCCH) and a Physical Downlink Shared Channel (PDSCH), using CC #2. The PDCCH is a physical channel for transmitting dedicated data transmission control information, and the Physical Downlink Shared Channel (PDSCH) is a physical channel for transmitting dedicated data. The base station 100a transmits the PMCH, using CC #1.

In this case, the mobile station 200 receives, using CC #1, wireless signals transmitted by the base stations 100 and 100a and combines the received wireless signals, to thereby extract the MBMS data. In addition, the mobile station 200 receives, using CC #2, a wireless signal transmitted by the base station 100 and extracts dedicated data directed to the mobile station 200 from the received signal. Note that the base station 100/100a is capable of transmitting MBMS data and dedicated data concurrently or at different times. The mobile station 200/200a may or may not be capable of receiving in parallel MBMS data and dedicated data transmitted at the same time. The second embodiment assumes that the mobile station 200 is capable of parallel reception of MBMS data and dedicated data while the mobile station 200a is incapable of the parallel data reception.

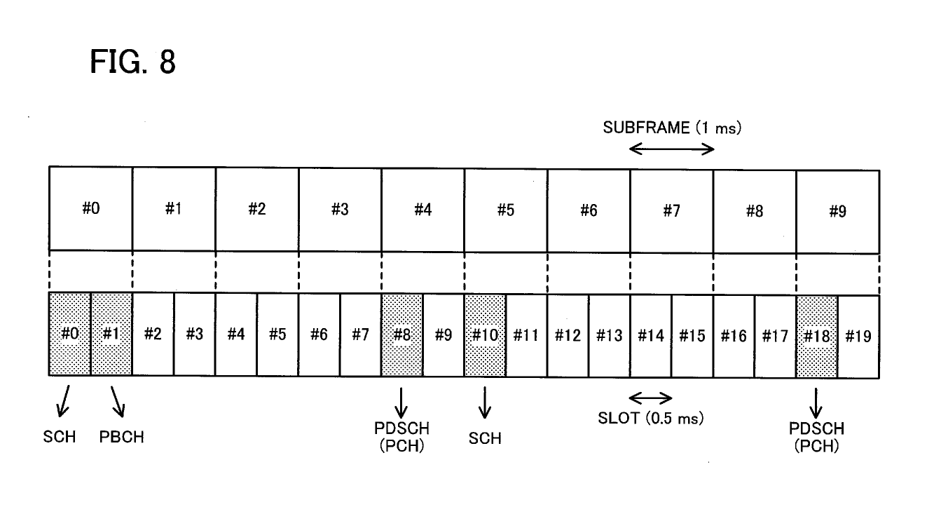

FIG. 8 illustrates a structural example of a wireless frame. In each of CCs #1 to #5, the wireless frame as illustrated in FIG. 8 is transmitted between the base station 100/100a and the mobile station 200/200a. Note however that the structure of FIG. 8 is merely an example, and the structure of the wireless frame is not limited to this example.

According to the example, the wireless frame with a duration of 10 ms includes 10 subframes (subframes #0 to #9) each having a duration of 1 ms. Each subframe includes two slots, each with a duration of 0.5 ms. That is, the 10-ms wireless frame includes 20 slots (slots #0 to #19).

For management purposes, wireless resources in the wireless frame are subdivided in the time and frequency directions. For example, as a multiplexing access scheme, Orthogonal Frequency Division Multiple Access (OFDMA) is used for the downlink, and Single-Carrier Frequency Division Multiple Access (SC-FDMA) or N×Discrete Fourier Transform spread Orthogonal Frequency Division Multiple Access (N×DFT-s-OFDM) is used for the uplink. Each slot includes 7 or 6 symbols in the time direction. In each symbol, a guard interval called “cyclic prefix” is inserted. In the frequency direction, each component carrier includes multiple subcarriers. Wireless resources defined in the time-frequency domain are assigned to each channel.

In a downlink wireless frame, a Synchronization Channel (SCH) for transmitting synchronization signals is assigned to slots #0 and #10. A Physical Broadcast Channel (PBCH), which is a physical broadcast channel for transmitting broadcast information, is assigned to slot #1. A Paging Channel (PCH), which is a transport channel used for paging the mobile station 200/200a, is assigned to slots #8 and #18. The PCH is mapped in the PDSCH, which is a physical channel.

Note that a subframe for transmitting MBMS data (MBSFN subframe) is selected from subframes #1 to #3 and #6 to #8, to which none of the SCH, the PBCH, and the PCH is assigned. The cyclic prefix length in the MBSFN subframe is different from that in other subframes (normal subframes), as described later, and therefore, the MBSFN subframe is not used to transmit dedicated data. As a result, MBMS data and dedicated data are not multiplexed in a single subframe.

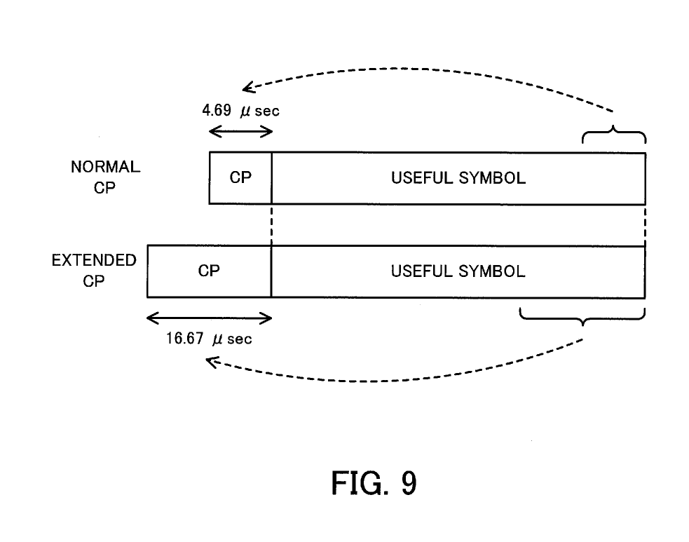

FIG. 9 illustrates a structural example of a symbol. The symbol includes a useful symbol which is a data portion and a cyclic prefix which is a guard interval, as depicted in FIG. 9. The cyclic prefix is a duplication of the last portion of the useful symbol, and is prefixed to the beginning of the useful symbol.

There are two types of cyclic prefixes of different lengths, a normal cyclic prefix and an extended cyclic prefix. The duration of the normal cyclic prefix is 4.69 μsec while the duration of the extended cyclic prefix is 16.67 μsec. The duration of the useful symbol stays the same regardless of using the normal cyclic prefix or the extended cyclic prefix. 7 symbols are included in one slot in the case where the normal cyclic prefix is used, and 6 symbols are included in one slot in the case where the extended cyclic prefix is used.

For a normal subframe, the normal cyclic prefixes are used, as a general rule. Therefore, each slot of a normal subframe includes 7 symbols. On the other hand, the extended cyclic prefixes are used for an MBSFN subframe. Therefore, each slot of an MBSFN subframe includes 6 symbols. The mobile station 200/200a is configured to combine a delay wave signal having a delay time equal to or less than the cyclic prefix length with a direct wave signal and other delay wave signals, and demodulate the composite signal. Compared to the use of the normal cyclic prefixes, the use of the extended cyclic prefixes allows the mobile station 200/200a in the process of extracting MBMS data to use wireless signals with larger delay time (for example, wireless signals transmitted from distant base stations) for the signal combination and demodulation.

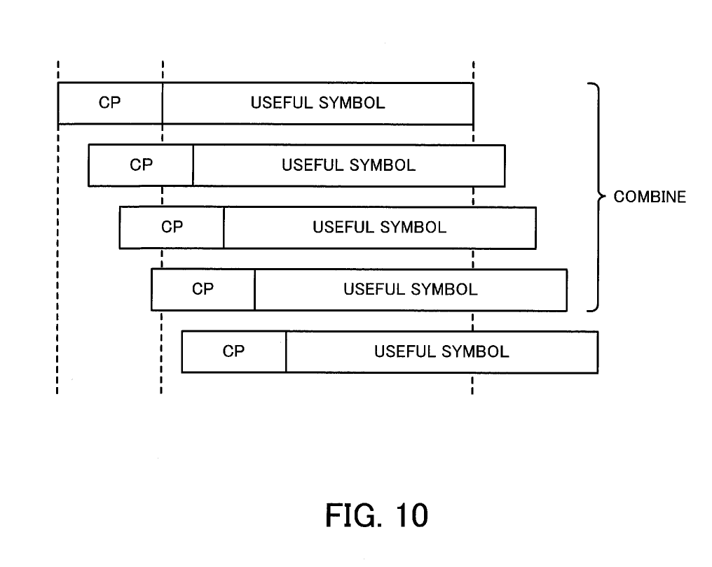

FIG. 10 illustrates a method for combining MBMS data signals. According to the example of FIG. 10, a signal formed by superimposing wireless signals transmitted from five base stations upon each other is received by the mobile station 200/200a as a signal formed by superimposing a direct wave signal and four delay wave signals upon each other. Three out of the four delay wave signals have a delay time equal to or less than the cyclic prefix length, and the remaining one has a delay time exceeding the cyclic prefix length. In this case, the mobile station 200/200a combines the direct wave signal and the three delay wave signals and demodulates the composite signal.

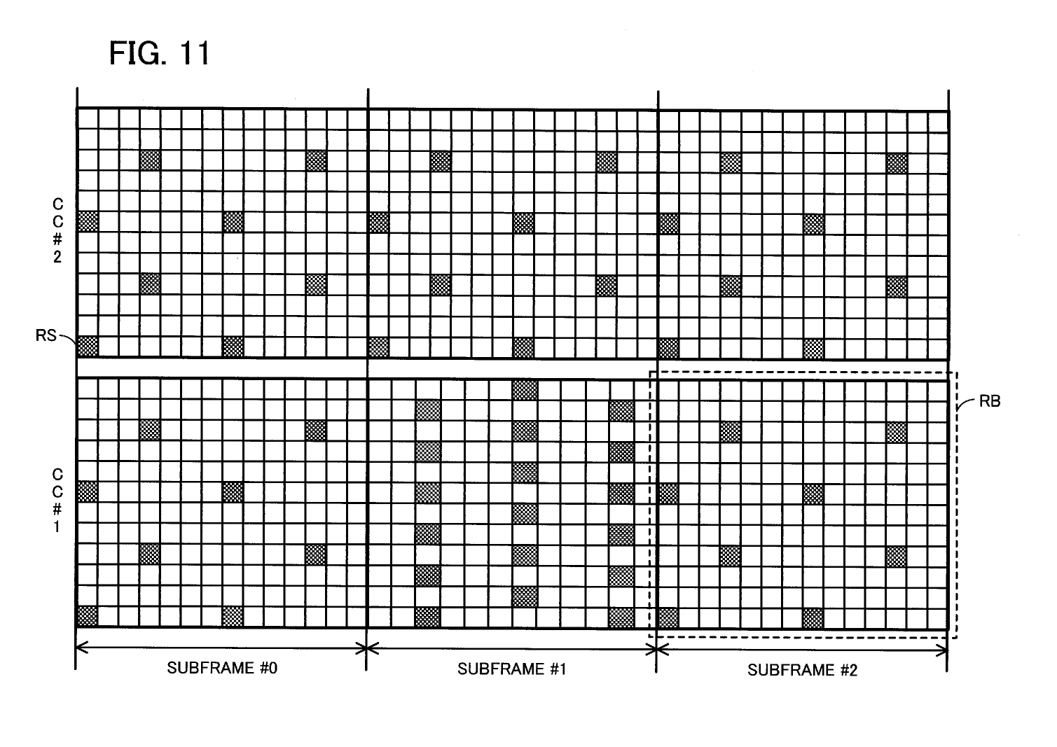

FIG. 11 illustrates a configuration example of normal subframes and an MBSFN subframe. In the example of FIG. 11, subframe #1 of CC #1 is set as an MBSFN subframe, and subframes #0 and #2 of CC #1 and subframes #0 to #2 of CC #2 are set as normal subframes. Note that, in each subframe, pilot signals called reference signals (RS) are transmitted. The reference signals are used to measure received quality at the mobile station 200/200a. The reference signals included in the normal subframes have a different signal sequence from that of the reference signals included in the MBSFN subframe.

Each of the normal subframes includes 14 symbols (7 symbols×2 slots) while the MBSFN subframe includes 12 symbols (6 symbols×2 slots), as described above. Therefore, at time of subframe #1, start positions of individual symbols are out of alignment between CCs #1 and #2, as illustrated in FIG. 11. In this situation, receiving in parallel subframe #1 of CC #1 and subframe #1 of CC #2 imposes, upon the mobile station 200/200a, a substantial burden associated with reception processes including extraction of useful symbols from received signals and a fast Fourier transform (FFT). As mentioned above, the second embodiment assumes that the mobile station 200 is capable of parallel reception of MBMS data and dedicated data while the mobile station 200a is incapable of the parallel data reception. The base station 100/100a schedules transmission of dedicated data directed to the mobile station 200/200a in consideration of the communication capabilities of the mobile station 200/200a.

To facilitate easy understanding, FIG. 11 depicts only one resource block (RB) in the frequency direction for each of the component carriers. However, each component carrier may include multiple resource blocks in the frequency direction. For example, a component carrier having a bandwidth of 1.4 MHz may include 6 resource blocks; a component carrier having a bandwidth of 3 MHz may include 15 resource blocks; a component carrier having a bandwidth of 5 MHz may include 25 resource blocks; a component carrier having a bandwidth of 10 MHz may include 50 resource blocks; a component carrier having a bandwidth of 15 MHz may include 75 resource blocks; and a component carrier having a bandwidth of 20 MHz may include 100 resource blocks.

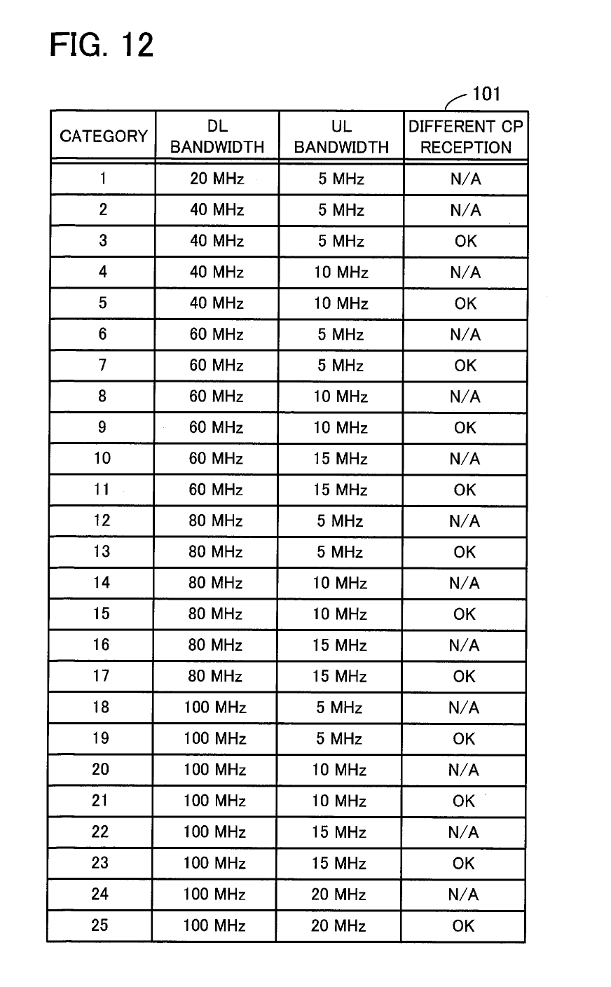

FIG. 12 is a table illustrating a first category example of mobile stations. Multiple mobile stations including the mobile stations 200 and 200a are classified into categories according to the communication capabilities. For example, when establishing a connection to the base station 100, the mobile station 200/200a notifies the base station 100 of a category of the mobile station 200/200a. A category table 101 of FIG. 12, for example, has been stored in the base station 100.

The category table 101 includes fields of “category identifier (ID)”, “downlink bandwidth”, “uplink bandwidth”, and “different cyclic prefix reception capability”. Each entry in the category identifier field is identification information for identifying a specific category. Each entry in the downlink bandwidth field indicates a maximum frequency bandwidth available for downlink communication. Each entry in the uplink bandwidth field indicates a maximum frequency bandwidth available for uplink communication. Each entry in the different cyclic prefix reception capability field is a flag indicating capability for concurrent reception of subframes with the normal cyclic prefixes and with the extended cyclic prefixes.

According to the category table 101 of FIG. 12, for example, a mobile station of Category 10 is able to use a bandwidth of 60 MHz or less for downlink communication and use a bandwidth of 15 MHz or less for uplink communication, and is incapable of handling in parallel the normal and the extended cyclic prefixes. A mobile station of Category 11 is able to use the same bandwidths as for the mobile station of Category 10 and also capable of handling in parallel the normal and the extended cyclic prefixes. Note that in FIG. 12, the downlink and uplink bandwidths are expressed in Hz, however, they may be expressed by the number of component carriers available for carrier aggregation.

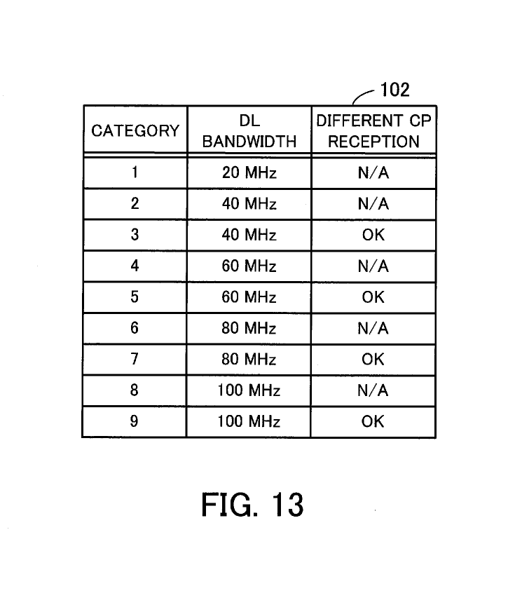

FIG. 13 is a table illustrating a second category example of mobile stations. Multiple mobile stations including the mobile stations 200 and 200a may be classified into categories based on a category table 102 of FIG. 13 in place of the category table 101. In that case, for example, the category table 102 is stored in the base station 100. The category table 102 includes fields of “category identifier (ID)”, “downlink bandwidth”, and “different cyclic prefix reception capability”. An uplink bandwidth of a mobile station of each category may be defined as being proportional to a corresponding downlink bandwidth. Alternatively, the mobile station 200/200a may notify the base station 100 of an uplink bandwidth separately from the category notification. This simplifies classification of mobile stations.

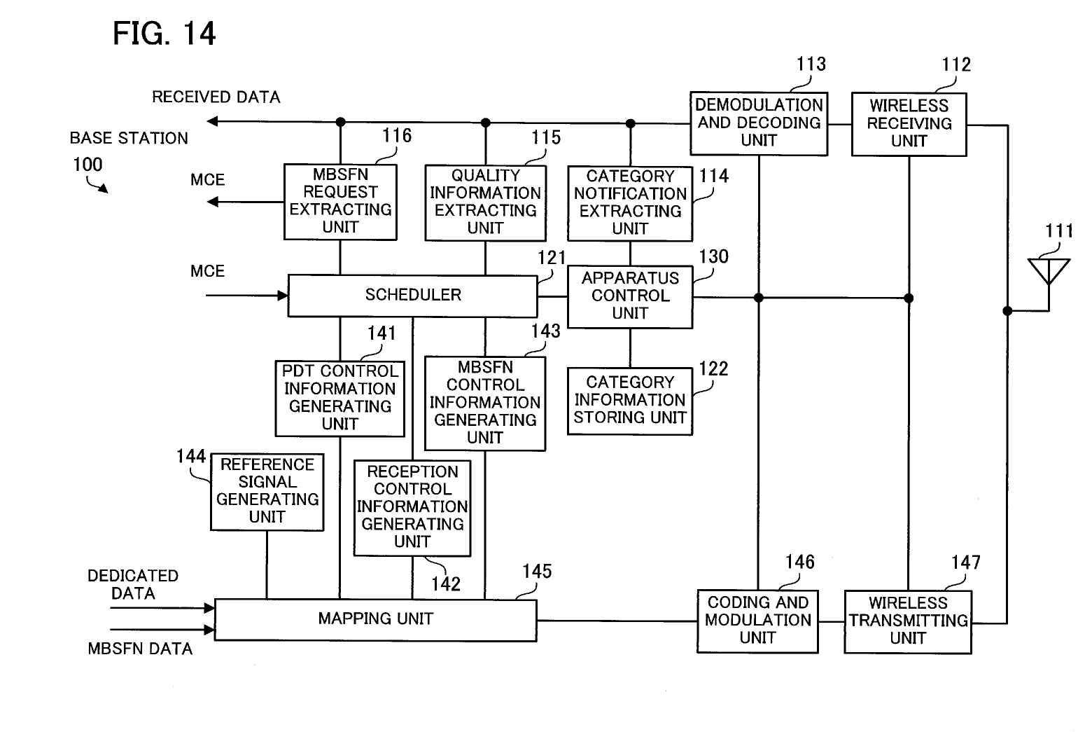

FIG. 14 is a block diagram of a base station according to the second embodiment. The base station 100 includes an antenna 111; a wireless receiving unit 112; a demodulation and decoding unit 113; a category notification extracting unit 114; a quality information extracting unit 115; an MBSFN request extracting unit 116; a scheduler 121; a category information storing unit 122; an apparatus control unit 130; a dedicated data transmission (PDT) control information generating unit 141; a reception control information generating unit 142; an MBSFN control information generating unit 143; a reference signal generating unit 144; a mapping unit 145; a coding and modulation unit 146; and a wireless transmitting unit 147. Other base stations including the base station 100a are also implemented using the same block architecture as the base station 100.

The antenna 111 receives a wireless signal transmitted from the mobile station 200/200a and outputs the wireless signal to the wireless receiving unit 112. The antenna 111 also outputs a transmission signal acquired from the wireless transmitting unit 147 as a wireless signal. Note that, instead of the two-way transmitting and receiving antenna, a transmitting antenna and a receiving antenna may be separately provided in the base station 100. Alternatively, the base station 100 may employ diversity transmission using multiple antennas.

The wireless receiving unit 112 carries out wireless signal processing on the received signal acquired from the antenna 111 and converts the high-frequency wireless signal into a baseband signal as a low-frequency signal (down-conversion). For the wireless signal processing, the wireless receiving unit 112 includes circuits such as a low noise amplifier (LNA), a quadrature demodulator, and an analog to digital converter (ADC).

The demodulation and decoding unit 113 demodulates and error-correction-decodes the baseband signal acquired from the wireless receiving unit 112. The baseband signal is demodulated and decoded by a method corresponding to a predetermined modulation and coding scheme (MCS) or a modulation and coding scheme instructed by the apparatus control unit 130. Extracted user data, which is dedicated data, obtained in this manner is transferred to the SAE gateway 430.

The category notification extracting unit 114 extracts a category notification transmitted by the mobile station 200/200a. The category notification includes, for example, a category identifier. The category notification is transmitted by the Physical Uplink Shared Channel (PUSCH) which is an uplink physical channel. The category notification extracting unit 114 outputs the extracted category notification to the apparatus control unit 130.

The quality information extracting unit 115 extracts quality information which is control information transmitted by the mobile station 200/200a and indicates a measurement report of received quality. As the quality information, a channel quality indicator (CQI) may be used, which represents the received quality using a discrete value. The quality information is transmitted by a Physical Uplink Control Channel (PUCCH) which is an uplink physical channel. The quality information extracting unit 115 outputs the extracted quality information to the scheduler 121.

The MBSFN request extracting unit 116 extracts an MBSFN request transmitted by the mobile station 200/200a and indicating a request for MBSFN transmission. The MBSFN request includes information on a selected MBMS service and is transmitted by the PUSCH. The MBSFN request extracting unit 116 outputs the extracted MBSFN request to the scheduler 121. In response to an instruction from the scheduler 121, the MBSFN request extracting unit 116 transfers the MBSFN request to the MCE 300.

The scheduler 121 schedules transmission of dedicated data to the mobile station 200/200a. In the scheduling, the scheduler 121 refers to the following three: the received quality of the mobile station 200/200a, indicated by the quality information acquired from the quality information extracting unit 115; the communication capabilities of the mobile station 200/200a, notified of by the apparatus control unit 130; and the transmission timing of the MBMS data indicated by the MBSFN control information received from the MCE 300. The scheduling includes allocation of wireless resources and selection of a modulation and coding scheme. The scheduler 121 notifies the PDT control information generating unit 141, the reception control information generating unit 142, and the apparatus control unit 130 of the scheduling result. In addition, based on the MBSFN control information received from the MCE 300, the scheduler 121 instructs the MBSFN control information generating unit 143 to transmit the PMCH (MCCH).

The category information storing unit 122 is a memory for prestoring category information indicating correspondence between category identifiers and communication capabilities of mobile stations. The category information storing unit 122 stores, for example, the category table 101 of FIG. 12.

Based on the category notification acquired from the category notification extracting unit 114 and the category information stored in the category information storing unit 122, the apparatus control unit 130 determines the communication capabilities of the mobile station 200/200a and notifies the scheduler 121 of the determined communication capabilities. In addition, based on the scheduling result of the scheduler 121, the apparatus control unit 130 controls receiving and transmitting processes of the wireless receiving unit 112, the demodulation and decoding unit 113, the coding and modulation unit 146, and the wireless transmitting unit 147.

According to the scheduling result of the scheduler 121, the PDT control information generating unit 141 generates PDT control information to be transmitted by the PDCCH. The PDT control information includes information indicating wireless resources used to transmit dedicated data and information indicating a modulation and coding scheme to be applied to the dedicated data. The PDT control information generating unit 141 outputs the generated PDT control information to the mapping unit 145.

According to an instruction from the scheduler 121, the reception control information generating unit 142 generates reception control information to be transmitted by the PDCCH. The reception control information indicates whether, in a process of receiving both dedicated data and MBMS data, the mobile station 200/200a is capable of receiving both the dedicated data and the MBMS data. The reception control information may indicate that the mobile station 200/200a is capable of receiving both the dedicated data and the MBMS data, or may indicate that the mobile station 200/200a is not capable of receiving the MBMS data. The reception control information generating unit 142 outputs the generated reception control information to the mapping unit 145.

In response to an instruction from the scheduler 121, the MBSFN control information generating unit 143 generates MBSFN control information to be transmitted by the PMCH (MCCH). The MBSFN control information includes information indicating a list of MBMS services (types of MBMS data) available for the mobile station 200/200a. The MBSFN control information also includes information indicating wireless resources used to transmit MBMS data and information indicating a modulation and coding scheme applied to the MBMS data. The MBSFN control information generating unit 143 outputs the generated MBSFN control information to the mapping unit 145.

The reference signal generating unit 144 generates reference signals which are known pilot signals, and outputs the generated reference signals to the mapping unit 145.

The mapping unit 145 maps, in a downlink wireless frame, MBMS data received from the MBMS gateway 420 and dedicated data received from the SAE gateway 430. In the downlink wireless frame, the mapping unit 145 also maps the control information acquired from the PDT control information generating unit 141, the reception control information generating unit 142, and the MBSFN control information generating unit 143, as well as the reference signals acquired from the reference signal generating unit 144. Subsequently, the mapping unit 145 sequentially outputs a mapped transmission signal to the coding and modulation unit 146.

The coding and modulation unit 146 error-correction-codes and modulates the transmission signal acquired from the mapping unit 145, and outputs a resultant signal to the wireless transmitting unit 147. For the coding and modulation, a predetermined modulation and coding scheme or a modulation and coding scheme instructed by the apparatus control unit 130 is used.

The wireless transmitting unit 147 carries out wireless signal processing on the transmission signal acquired from the coding and modulation unit 146 to thereby convert the baseband signal as a low-frequency signal into a high-frequency wireless signal (up-conversion). For the wireless signal processing, the wireless transmitting unit 147 includes circuits such as a digital to analog converter (DAC), a quadrature modulator, and a power amplifier.

Note that an integration of the PDT control information generating unit 141, the reception control information generating unit 142, the MBSFN control information generating unit 143, the reference signal generating unit 144, the mapping unit 145, the coding and modulation unit 146, and the wireless transmitting unit 147 may be considered as an example of the transmitting unit 11 of the first embodiment. An integration of the scheduler 121 and the apparatus control unit 130 may be considered as an example of the control unit 12 of the first embodiment.

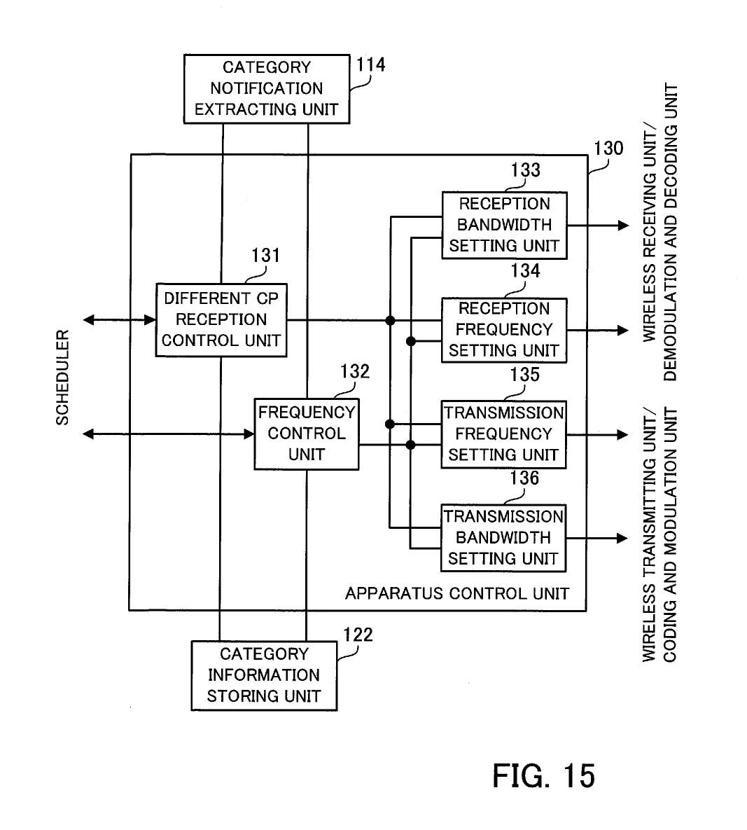

FIG. 15 is a block diagram of an apparatus control unit of a base station. The apparatus control unit 130 includes a different cyclic prefix (CP) reception control unit 131; a frequency control unit 132; a reception bandwidth setting unit 133; a reception frequency setting unit 134; a transmission frequency setting unit 135; and a transmission bandwidth setting unit 136. Note that FIG. 15 omits illustration of control of a modulation and coding scheme.

The different CP reception control unit 131 determines whether the mobile station 200/200a is capable of handling in parallel cyclic prefixes of different lengths, based on the category notification acquired from the category notification extracting unit 114 and the category information stored in the category information storing unit 122, and notifies the scheduler 121 of the determined result. In addition, based on a scheduling result of the scheduler 121, the different CP reception control unit 131 notifies the reception bandwidth setting unit 133, the reception frequency setting unit 134, the transmission frequency setting unit 135, and the transmission bandwidth setting unit 136 of settings for concurrent transmission of the normal and the extended cyclic prefixes.

The frequency control unit 132 determines bandwidths available for the mobile station 200/200a to use for wireless communication, based on the category notification acquired from the category notification extracting unit 114 and the category information stored in the category information storing unit 122, and notifies the scheduler 121 of the determined bandwidths. In addition, based on a scheduling result of the scheduler 121, the frequency control unit 132 notifies the reception bandwidth setting unit 133, the reception frequency setting unit 134, the transmission frequency setting unit 135, and the transmission bandwidth setting unit 136 of settings for frequencies to be used.

The reception bandwidth setting unit 133 selects, within the bandwidth of CCs #1 to #5 of the uplink, a bandwidth for receiving a wireless signal from the mobile station 200/200a, based on the notifications of the different CP reception control unit 131 and the frequency control unit 132. The reception frequency setting unit 134 selects, from among CCs #1 to #5 of the uplink, a component carrier for receiving the wireless signal from the mobile station 200/200a, based on the notifications of the different CP reception control unit 131 and the frequency control unit 132.

The transmission frequency setting unit 135 selects, from among CCs #1 to #5 of the downlink, a component carrier for transmitting a wireless signal to the mobile station 200/200a, based on the notifications of the different CP reception control unit 131 and the frequency control unit 132. The transmission bandwidth setting unit 136 selects, within the bandwidth of CCs #1 to #5 of the downlink, a bandwidth for transmitting the wireless signal to the mobile station 200/200a, based on the notifications of the different CP reception control unit 131 and the frequency control unit 132.

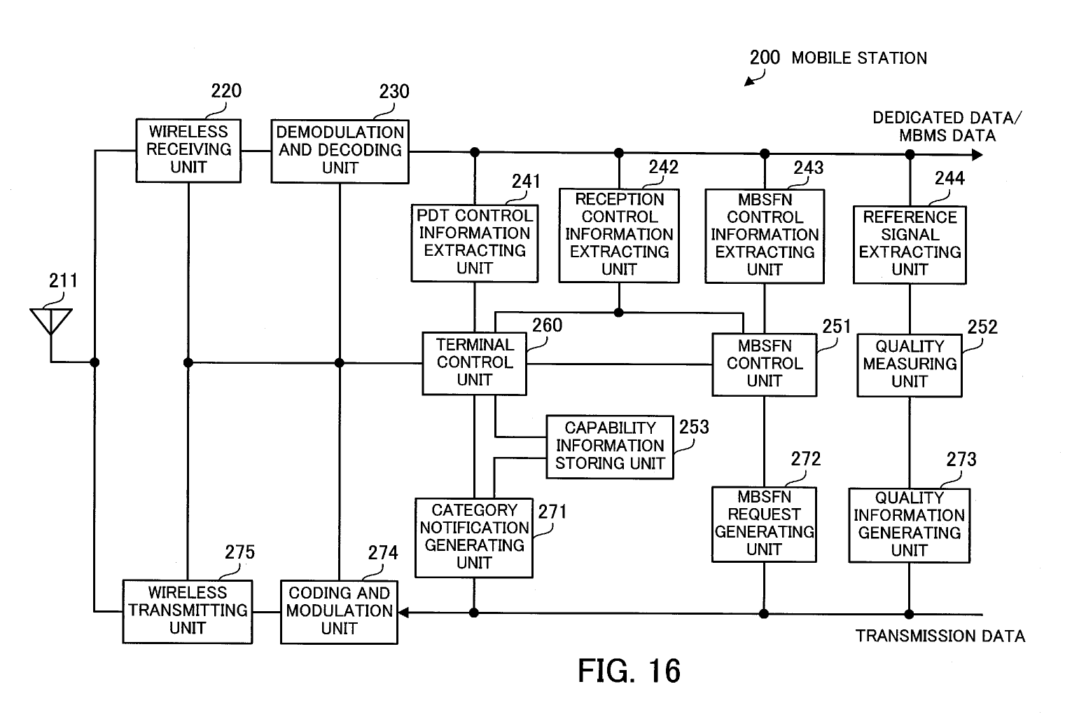

FIG. 16 is a block diagram of a mobile station according to the second embodiment. The mobile station 200 includes an antenna 211; a wireless receiving unit 220; a demodulation and decoding unit 230; a PDT control information extracting unit 241; a reception control information extracting unit 242; an MBSFN control information extracting unit 243; a reference signal extracting unit 244; an MBSFN control unit 251; a quality measuring unit 252; a capability information storing unit 253; a terminal control unit 260; a category notification generating unit 271; an MBSFN request generating unit 272; a quality information generating unit 273; a coding and modulation unit 274; and a wireless transmitting unit 275. Note that the mobile station 200a is also implemented using the same block architecture as that of the mobile station 200.

The antenna 211 receives a wireless signal transmitted from one or more base stations including the base station 100, and outputs the received wireless signal to the wireless receiving unit 220. The antenna 211 also wirelessly outputs a transmission signal acquired from the wireless transmitting unit 275. Note that, instead of the two-way transmitting and receiving antenna, a transmitting antenna and a receiving antenna may be separately provided in the mobile station 200. Alternatively, the mobile station 200 may employ diversity reception using multiple antennas.

The wireless receiving unit 220 carries out wireless signal processing on the received signal acquired from the antenna 211 and downconverts the wireless signal into a baseband signal. For the wireless signal processing, the wireless receiving unit 220 includes circuits such as an LNA, a quadrature demodulator, and an analog to digital converter (ADC).

The demodulation and decoding unit 230 demodulates and error-correction-decodes the baseband signal acquired from the wireless receiving unit 220. The baseband signal is demodulated and decoded by a method corresponding to a predetermined modulation and coding scheme (MCS) or a modulation and coding scheme instructed by the terminal control unit 260. Extracted dedicated data and MBMS data are transferred to a data processing unit of an upper layer (not illustrated), such as a processor.

The case is considered that the mobile station 200 receives MBMS data sent by MBSFN transmission. A signal that the mobile station 200 receives is formed by superimposing signals of the same content transmitted from multiple base stations upon each other. The received signal appears to the mobile station 200 as superposition of direct and delay waves. The demodulation and decoding unit 230 extracts delay wave signals each having a delay time equal to or less than the cyclic prefix length and combines the delay wave signals with the direct wave signal, and then demodulates and decodes the composite signal.

The PDT control information extracting unit 241 extracts PDT control information transmitted by the PDCCH. The PDT control information includes information indicating wireless resources used to transmit dedicated data and information indicating a modulation and coding scheme to be applied to the dedicated data, as described above. The PDT control information extracting unit 241 outputs the extracted PDT control information to the terminal control unit 260.

The reception control information extracting unit 242 extracts reception control information transmitted by the PDCCH. The reception control information indicates whether the mobile station 200 is capable of receiving both dedicated data and MBMS data, as described above. The reception control information extracting unit 242 outputs the extracted reception control information to the terminal control unit 260 and the MBSFN control unit 251.

The MBSFN control information extracting unit 243 extracts MBSFN control information transmitted by the PMCH (MCCH). The MBSFN control information includes information indicating a list of available MBMS services, information indicating wireless resources used to transmit MBMS data, and information indicating a modulation and coding scheme to be applied to the MBMS data. The MBSFN control information extracting unit 243 outputs the extracted MBSFN control information to the MBSFN control unit 251.

The reference signal extracting unit 244 extracts reference signals included in a downlink wireless frame and outputs the extracted reference signals to the quality measuring unit 252.

The MBSFN control unit 251 instructs the MBSFN request generating unit 272 to transmit an MBSFN request in order to start reception of MBMS data in response to, for example, a user's operation. In addition, the MBSFN control unit 251 notifies the terminal control unit 260 of information used for receiving MBMS data, such as a timing of MBMS data transmission, based on the MBSFN control information acquired from the MBSFN control information extracting unit 243. Note however that if the reception control information acquired from the reception control information extracting unit 242 indicates that the mobile station 200 is incapable of receiving MBMS data, the MBSFN control unit 251 controls the mobile station 200 not to receive MBMS data.

The quality measuring unit 252 measures received quality, such as a Carrier to Interference Ratio (CIR), or wireless channel quality, using the reference signals acquired from the reference signal extracting unit 244. Subsequently, the quality measuring unit 252 outputs the measurement result to the quality information generating unit 273 and also feeds the measurement result back to the reference signal extracting unit 244.

The capability information storing unit 253 is a memory for prestoring capability information of the mobile station 200. The capability information indicates uplink and downlink bandwidths available for wireless communication of the mobile station 200 and capability of the mobile station 200 to handle in parallel cyclic prefixes of different lengths. The capability information storing unit 253 may store a category identifier as the capability information.

The terminal control unit 260 controls reception of dedicated data directed to the mobile station 200 and transmission of user data to the base station 100, based on the PDT control information acquired from the PDT control information extracting unit 241. In addition, the terminal control unit 260 controls reception of MBMS data based on the reception control information acquired from the reception control information extracting unit 242 and the notification from the MBSFN control unit 251. The terminal control unit 260 also instructs the category notification generating unit 271 to transmit a category notification to the base station 100 when the mobile station 200 establishes a connection to the base station 100.

In response to the instruction of the terminal control unit 260, the category notification generating unit 271 generates a category notification by reading the capability information from the capability information storing unit 253. If the capability information indicates information other than a category identifier, the category notification generating unit 271 calculates a category of the mobile station 200 from communication performance indicated by the capability information, to thereby determine a category identifier. The category notification generating unit 271 outputs the generated category notification to the coding and modulation unit 274. Note that, in the description above, the mobile station 200 notifies the base station 100 of the category identifier. However, the above-mentioned capability information indicating information other than a category identifier may be notified of instead.

The MBSFN request generating unit 272 generates an MBSFN request indicating a request for MBSFN transmission, in response to an instruction of the MBSFN control unit 251. The MBSFN request includes information indicating a MBMS service selected from the list notified of by the base station 100. The MBSFN request generating unit 272 outputs the generated MBSFN request to the coding and modulation unit 274.

The quality information generating unit 273 generates quality information indicating the received quality or the wireless channel quality measured by the quality measuring unit 252. As the quality information, the CQI, for example, may be used. The quality information generating unit 273 outputs the generated quality information to the coding and modulation unit 274.

The coding and modulation unit 274 error-correction-codes and modulates the user data to be transmitted by the PUSCH, the category notification acquired from the category notification generating unit 271, the MBSFN request acquired from the MBSFN request generating unit 272, and the quality information acquired from the quality information generating unit 273, and then outputs the coded and modulated result (transmission signal) to the wireless transmitting unit 275. For the coding and modulation, a predetermined modulation and coding scheme or a modulation and coding scheme instructed by the terminal control unit 260 is used.

The wireless transmitting unit 275 carries out wireless signal processing on the transmission signal acquired from the coding and modulation unit 274 to thereby upconvert the baseband signal into a wireless signal. For the wireless signal processing, the wireless transmitting unit 275 includes circuits such as a DAC, a quadrature modulator, and a power amplifier.

Note that an integration of the wireless receiving unit 220, the demodulation and decoding unit 230, the PDT control information extracting unit 241, the reception control information extracting unit 242, the MBSFN control information extracting unit 243, and the reference signal extracting unit 244 may be considered as an example of the receiving unit 21 of the first embodiment. An integration of the category notification generating unit 271, the coding and modulation unit 274, and the wireless transmitting unit 275 may be considered as an example of the notifying unit 22 of the first embodiment.

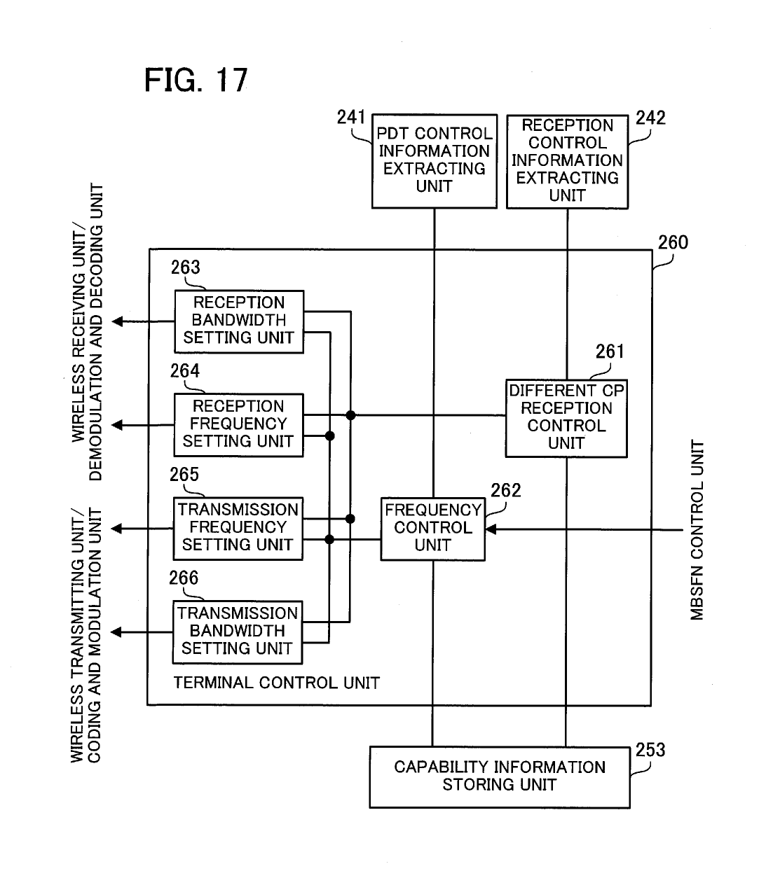

FIG. 17 is a block diagram of a terminal control unit of a mobile station. The terminal control unit 260 includes a different cyclic prefix (CP) reception control unit 261, a frequency control unit 262, a reception bandwidth setting unit 263, a reception frequency setting unit 264, a transmission frequency setting unit 265, and a transmission bandwidth setting unit 266. Note that FIG. 17 omits illustration of control of a modulation and coding scheme.

The different CP reception control unit 261 determines whether to concurrently receive the normal and the extended cyclic prefixes, based on the reception control information acquired from the reception control information extracting unit 242 and the capability information of the mobile station 200, stored in the capability information storing unit 253. Subsequently, the different CP reception control unit 261 notifies the reception bandwidth setting unit 263, the reception frequency setting unit 264, the transmission frequency setting unit 265, and the transmission bandwidth setting unit 266 of the determined setting regarding the concurrent reception.

The frequency control unit 262 notifies the reception bandwidth setting unit 263, the reception frequency setting unit 264, the transmission frequency setting unit 265, and the transmission bandwidth setting unit 266 of setting for frequencies to be used, based on the PDT control information acquired from the PDT control information extracting unit 241, the notification from the MBSFN control unit 251, and the capability information of the mobile station 200, stored in the capability information storing unit 253.

The reception bandwidth setting unit 263 selects, within the bandwidth of CCs #1 to #5 of the downlink, a bandwidth for receiving a wireless signal, based on the notifications of the different CP reception control unit 261 and the frequency control unit 262. The reception frequency setting unit 264 selects, from among CCs #1 to #5 of the downlink, a component carrier for receiving the wireless signal, based on the notifications of the different CP reception control unit 261 and the frequency control unit 262.

The transmission frequency setting unit 265 selects, from among CCs #1 to #5 of the uplink, a component carrier for transmitting a wireless signal to the base station 100, based on the notifications of the different CP reception control unit 261 and the frequency control unit 262. The transmission bandwidth setting unit 266 selects, within the bandwidth of CCs #1 to #5 of the uplink, a bandwidth for transmitting the wireless signal to the base station 100, based on the notifications of the different CP reception control unit 261 and the frequency control unit 262.

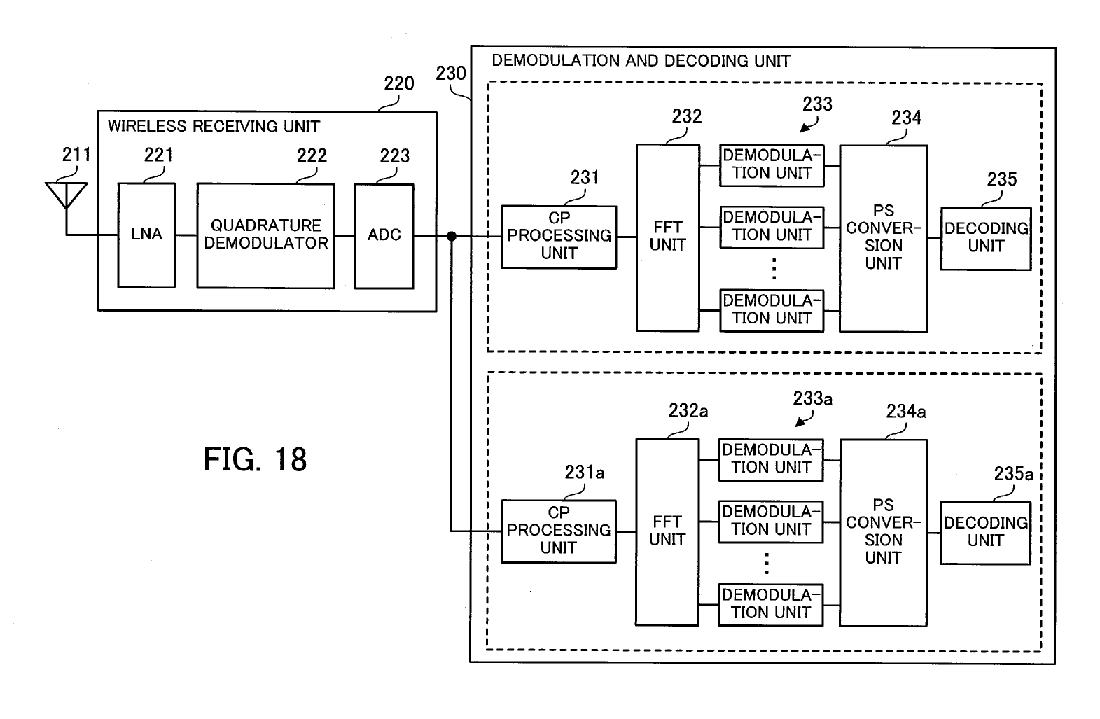

FIG. 18 is a block diagram of a first example of a reception circuit of a mobile station. The example of FIG. 18 illustrates the case where the mobile station 200 does not employ spectrum aggregation. Note that the demodulation and decoding unit 230 is capable of handling in parallel the normal and the extended cyclic prefixes, as described above.

The wireless receiving unit 220 processes a wireless signal of one or more component carriers belonging to a single frequency band (for example, the 800 MHz frequency band or the 3.5 GHz frequency band). The wireless receiving unit 220 includes an LNA 221, a quadrature demodulator 222, and an ADC 223. The LNA 221 amplifies a signal received by the antenna 211. The quadrature demodulator 222 quadrature-demodulates the received signal to thereby extract an in-phase component and a quadrature component. The ADC 223 converts the analog baseband signal into a digital baseband signal and outputs the digital baseband signal to the demodulation and decoding unit 230.

The demodulation and decoding unit 230 includes cyclic prefix (CP) processing units 231 and 231a, fast Fourier transform (FFT) units 232 and 232a, demodulation units 233 and 233a, parallel-to-serial (PS) conversion units 234 and 234a, and decoding units 235 and 235a. In the case of receiving normal subframes and MBSFN subframes, the CP processing unit 231, the FFT unit 232, the demodulation units 233, the parallel-to-serial conversion unit 234, and the decoding unit 235 process the normal subframes, and the CP processing unit 231a, the FFT unit 232a, the demodulation units 233a, the parallel-to-serial conversion unit 234a, and the decoding unit 235a process the MBSFN subframes.

The CP processing unit 231 extracts useful symbols by deleting the normal cyclic prefixes from the digital baseband signal acquired from the wireless receiving unit 220. The CP processing unit 231a extracts useful symbols by deleting the extended cyclic prefixes from the digital baseband. The FFT unit 232/232a runs a FFT on the useful symbols and converts a signal on the time axis into a signal with frequency components. The demodulation units 233/233a digitally demodulate the fast Fourier transformed signal with respect to each of the frequency components. The parallel-to-serial conversion unit 234/234a converts parallel signals of the frequency components into a serial signal (de-mapping). The decoding unit 235/235a error-correction-decodes the de-mapped signal.

As described above, the wireless receiving unit 220 is able to collectively handle a component carrier in which normal subframes are transmitted and a component carrier in which MBSFN subframes are transmitted if these component carriers belong to the same frequency band. On the other hand, the demodulation and decoding unit 230 has two receiving systems in order to concurrently process the normal subframes and the MBSFN subframes with cyclic prefixes of different lengths.

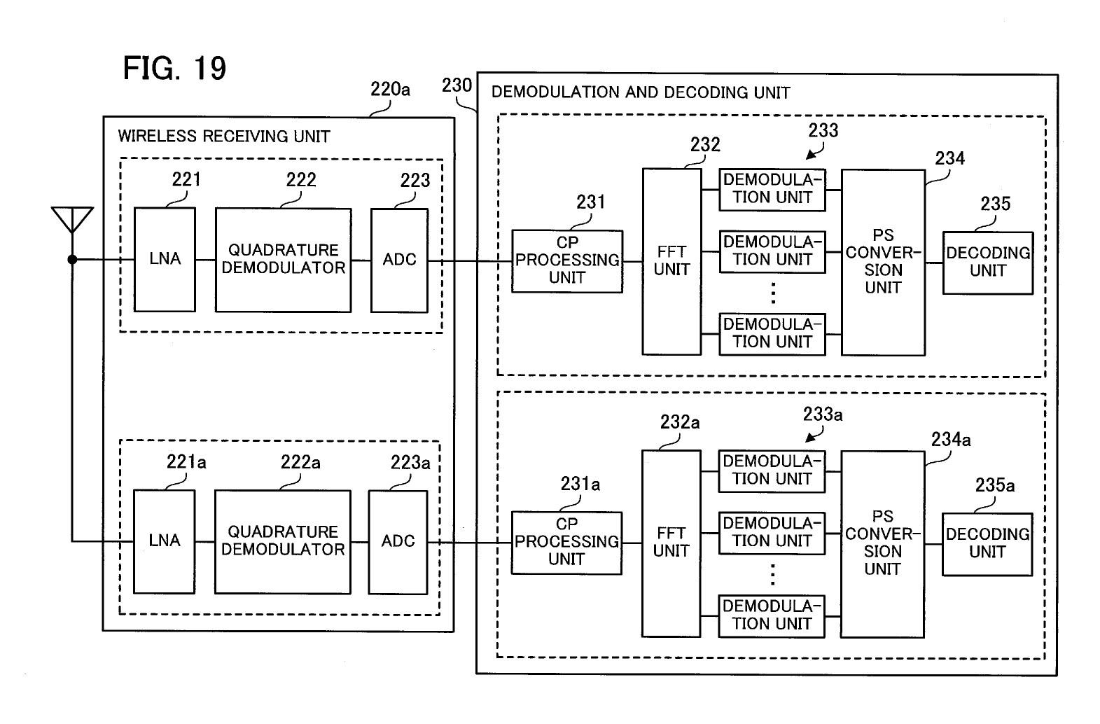

FIG. 19 is a block diagram of a second example of a reception circuit of a mobile station. The example of FIG. 19 illustrates the case where the mobile station 200 employs spectrum aggregation. In this case, the mobile station 200 has a wireless receiving unit 220a in place of the wireless receiving unit 220.

The wireless receiving unit 220a includes LNAs 221 and 221a, quadrature demodulators 222 and 222a, and ADCs 223 and 223a. The LNA 221, the quadrature demodulator 222, and the ADC 223 handle a component carrier belonging to one frequency band (for example, the 3.5 GHz frequency band), and the LNA 221a, the quadrature demodulator 222a, and the ADC 223a handle a component carrier belonging to another frequency band (for example, the 800 MHz frequency band). Thus, the wireless receiving unit 220a and the demodulation and decoding unit 230 each have two receiving systems so as to concurrently process normal subframes and MBSFN subframes individually transmitted in two component carriers which belong to different frequency bands.

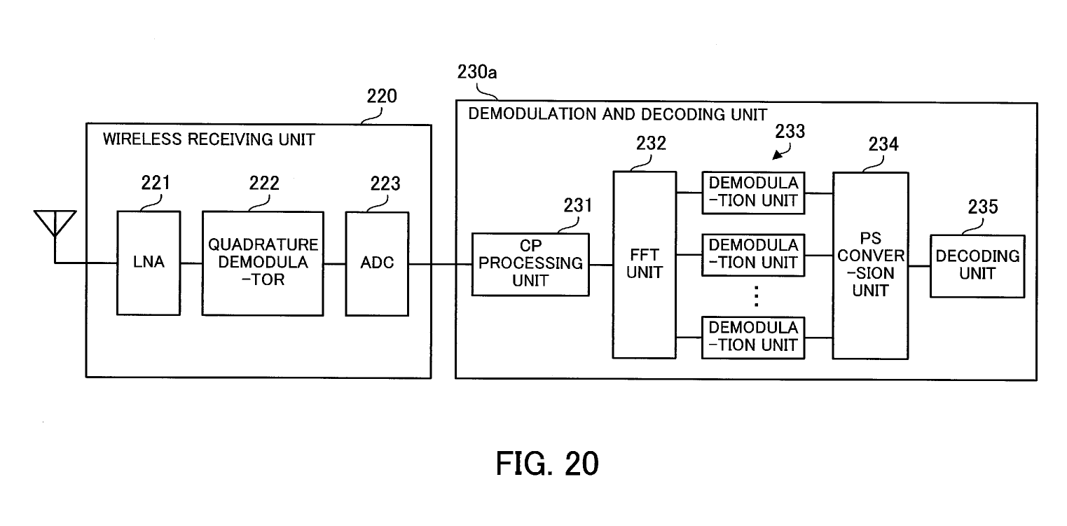

FIG. 20 is a block diagram of a third example of a reception circuit of a mobile station. The example of FIG. 20 illustrates a receiving circuit mounted on the mobile station 200a incapable of handling in parallel the normal and the extended cyclic prefixes. The mobile station 200a includes, for example, the wireless receiving unit 220 and a demodulation and decoding unit 230a.

The demodulation and decoding unit 230a includes the CP processing unit 231, the FFT unit 232, the demodulation units 233, the parallel-to-serial conversion unit 234, and the decoding unit 235. In the CP processing unit 231 and the FFT unit 232, a setting for receiving either a normal subframe or an MBSFN subframe is designated for each subframe time duration (1 ms). According to the setting, the CP processing unit 231 deletes the normal cyclic prefixes or the extended cyclic prefixes to extract useful symbols. The FFT unit 232 executes a FFT on the useful symbols at a timing according to the setting to obtain a signal with frequency components. Thus, the demodulation and decoding unit 230a is not capable of concurrently processing normal subframes and MBSFN subframes having cyclic prefixes of different lengths.

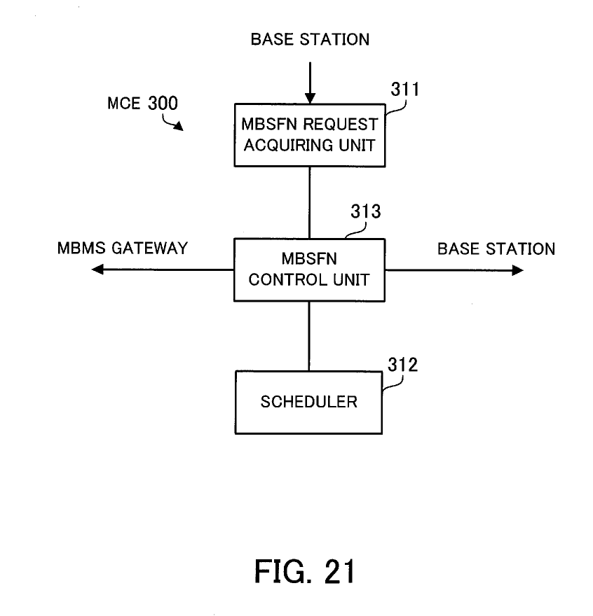

FIG. 21 is a block diagram of a Multi-cell/multicast Coordination Entity (MCE) according to the second embodiment. The MCE 300 includes an MBSFN request acquiring unit 311, a scheduler 312, and an MBSFN control unit 313.

The MBSFN request acquiring unit 311 receives, from the base station 100/100a, an MBSFN request transmitted by the mobile station 200/200a. The MBSFN request acquiring unit 311 outputs the received MBSFN request to the MBSFN control unit 313.

The scheduler 312 schedules transmission of MBMS data to be sent by MBSFN transmission according to an instruction of the MBSFN control unit 313. The scheduling includes selection of a timing for transmitting MBMS data (including selection of a slot and a subframe used to transmit the MBMS data) and selection of a modulation and coding scheme applied to the MBMS data. In the scheduling, it is determined whether a type of MBMS data designated by the MBSFN control unit 313 has already been transmitted in the MBSFN area. If the type of MBMS data has already been transmitted, new wireless resources may not need to be allocated for transmitting the MBMS data.

The MBSFN control unit 313 transmits, to the base stations 100 and 100a, MBSFN control information indicating a list of MBMS services to be provided. On acquiring an MBSFN request from the MBSFN request acquiring unit 311, the MBSFN control unit 313 instructs the scheduler 312 to schedule transmission of MBMS data corresponding to the requested MBMS service. The MBSFN control unit 313 transmits MBSFN control information indicating a scheduling result (including a timing for transmitting the MBMS data and a modulation and coding scheme) to the base stations 100 and 100a and the MBMS gateway 420.

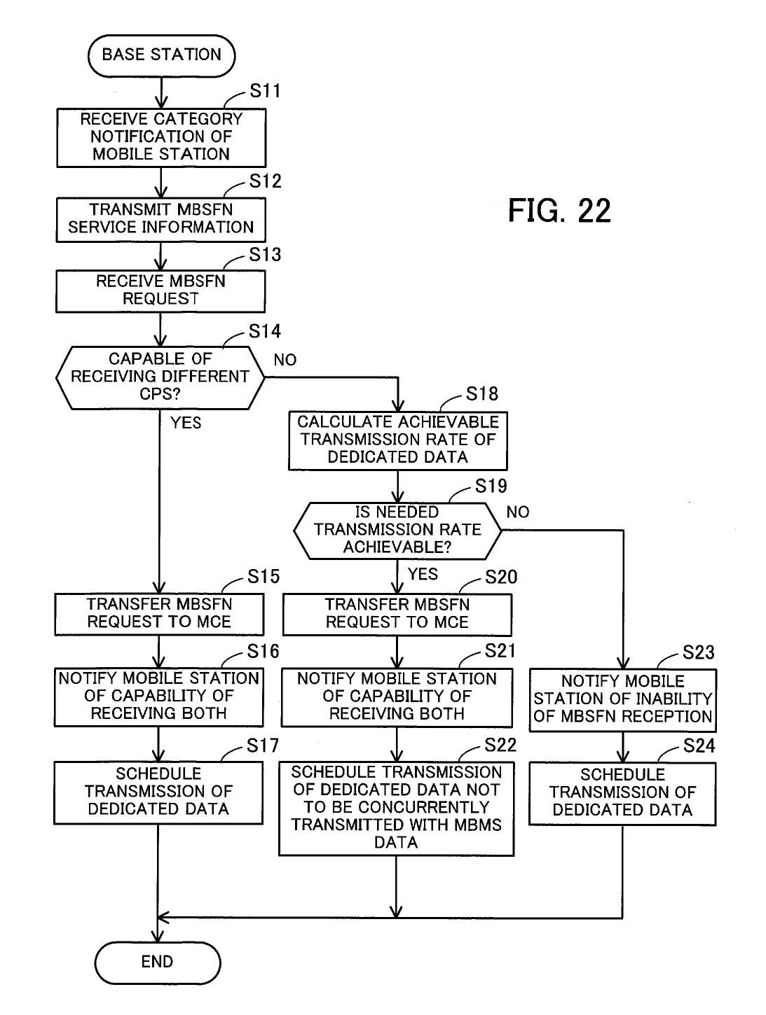

FIG. 22 is a flowchart illustrating a transmission process of a base station. The transmission process of FIG. 22 is described next according to the step numbers in the flowchart.

(Step S11) The wireless receiving unit 112 receives a category notification (for example, a category identifier) from the mobile station 200/200a when the mobile station 200/200a establishes a connection to the base station 100. The category notification extracting unit 114 extracts the category notification. The apparatus control unit 130 determines communication capabilities of the mobile station 200/200a based on the category notification.

(Step S12) The MBSFN control information generating unit 143 generates MBSFN service information which is a list of MBMS services, based on information received from the MCE 300. The wireless transmitting unit 147 transmits the MBSFN service information by the PMCH (MCCH).

(Step S13) The wireless receiving unit 112 receives an MBSFN request by the PUSCH. The MBSFN request extracting unit 116 extracts the MBSFN request.

(Step S14) The scheduler 121 determines whether a mobile station having transmitted the MBSFN request (hereinafter sometimes referred to as the “requesting mobile station”) is capable of concurrently receiving the normal and the extended cyclic prefixes, based on the communication capabilities determined in step S11. If the determination is affirmative (i.e., in the case where the requesting mobile station is the mobile station 200), the process moves to step S15. If the determination is negative (i.e., in the case where the requesting mobile station is the mobile station 200a), the process moves to step S18.

(Step S15) The MBSFN request extracting unit 116 transfers the MBSFN request extracted in step S13 to the MCE 300.

(Step S16) The reception control information generating unit 142 generates reception control information indicating that the requesting mobile station is capable of receiving both dedicated data directed to the mobile station 200 and MBMS data at the same time. The wireless transmitting unit 147 transmits the generated reception control information to the mobile station 200 by the PDCCH.

(Step S17) The scheduler 121 schedules transmission of the dedicated data directed to the mobile station 200. At this point, the position of an MBSFN subframe has been determined by the MCE 300. For the transmission of the dedicated data directed to the mobile station 200, the scheduler 121 may use subframes in component carriers, to be transmitted at the same timing as the MBSFN subframe, which component carriers are different from a component carrier in which the MBSFN subframe is transmitted.

(Step S18) The scheduler 121 determines wireless resources available for transmission of dedicated data directed to the mobile station 200a. In the determination of wireless resources, the number of component carriers that the mobile station 200a is able to concurrently receive and availability of wireless resources are taken into consideration. In addition, the scheduler 121 calculates an upper limit of the transmission rate per subframe of each component carrier, based on the received quality of the mobile station 200a. Subsequently, based on the available wireless resources and the transmission rate per subframe, the scheduler 121 calculates an achievable transmission rate of the dedicated data.

The wireless resources available for the mobile station 200a do not include subframes in component carriers, to be transmitted at the same timing as an MBSFN subframe, which component carriers are different from a component carrier in which the MBSFN subframe is transmitted. Assume that, for example, the mobile station 200a uses CCs #1 and #2, and that an MBSFN subframe is transmitted using CC #1. In this case, a subframe of CC #2, aligned at the same point in time as the MBSFN subframe, is excluded from the available wireless resources.

(Step S19) The scheduler 121 compares a transmission rate that the dedicated data directed to the mobile station 200a needs to achieve (needed transmission rate) and the achievable transmission rate calculated in step S18. If the achievable transmission rate is equal to or more than the needed transmission rate, the process moves to step S20. If the achievable transmission rate is less than the needed transmission rate, the process moves to step S23.

(Step S20) The MBSFN request extracting unit 116 transfers the MBSFN request extracted in step S13 to the MCE 300.

(Step S21) The reception control information generating unit 142 generates reception control information indicating that the requesting mobile station is capable of receiving both dedicated data directed to the mobile station 200a and MBMS data. The wireless transmitting unit 147 transmits the generated reception control information to the mobile station 200a by the PDCCH.

(Step S22) The scheduler 121 schedules transmission of the dedicated data directed to the mobile station 200a. At this point, for the transmission of the dedicated data directed to the mobile station 200a, the scheduler 121 does not use subframes in component carriers, to be transmitted at the same timing as an MBSFN subframe, which component carriers are different from a component carrier in which the MBSFN subframe is transmitted.

(Step S23) The reception control information generating unit 142 generates reception control information indicating that the requesting mobile station is not able to receive MBMS data sent by MBSFN transmission. The wireless transmitting unit 147 transmits the generated reception control information to the mobile station 200a by the PDCCH. Note that the MBSFN request received in step S13 is discarded.

(Step S24) The scheduler 121 schedules transmission of the dedicated data directed to the mobile station 200a. At this point, for the transmission of the dedicated data directed to the mobile station 200a, the scheduler 121 may use subframes in component carriers, to be transmitted at the same timing as an MBSFN subframe, which component carriers are different from a component carrier in which the MBSFN subframe is transmitted.

As described above, in the case where an MBSFN-requesting mobile station is capable of handling in parallel the normal and the extended cyclic prefixes, the base station 100 schedules transmission of dedicated data without restrictions associated with the transmission of MBMS data. On the other hand, if the MBSFN-requesting mobile station is not capable of handling in parallel the normal and the extended cyclic prefixes, the base station 100 determines whether MBMS data and dedicated data are allowed to be transmitted at different times. If MBMS data and dedicated data are not allowed to be transmitted at different times, the base station 100 instructs the requesting mobile station to receive dedicated data in preference to MBMS data (i.e., instructs not to receive MBMS data).

According to the second embodiment, in the case where a requesting mobile station is incapable of concurrently receiving MBMS data and dedicated data, the base station 100 instructs the mobile station to preferentially receive dedicated data. Note however that the base station 100 may instruct the mobile station to preferentially receive MBMS data. In addition, the base station 100 of the second embodiment transmits the reception control information regardless of whether the requesting mobile station is capable of concurrently receiving MBMS data and dedicated data. Alternatively, the reception control information may be transmitted only if the requesting mobile station is not capable of the concurrent reception.

In the example of FIG. 22, whether the requesting mobile station is capable of handling in parallel the normal and the extended cyclic prefixes is determined first, and then, when the mobile station is incapable of the parallel handling, whether the transmission of dedicated data meets the needed transmission rate is determined. Note however that, the determination order may be reversed. That is, whether the transmission of dedicated data meets the needed transmission rate is determined first, and then, when the transmission of the dedicated data does not meet the needed transmission rate, whether the requesting mobile station is capable of the parallel handling is determined.

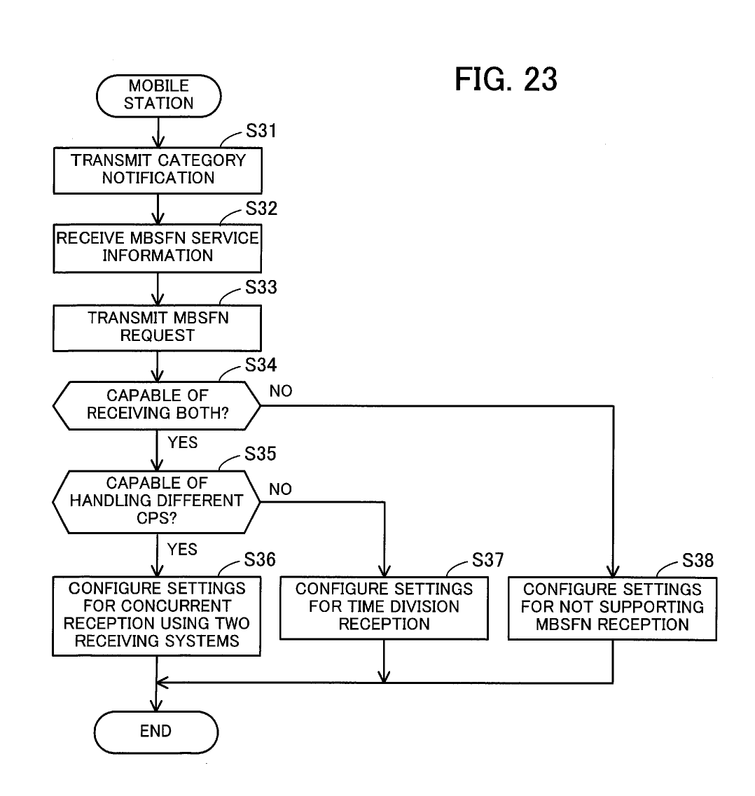

FIG. 23 is a flowchart illustrating a reception process of a mobile station. The reception process of FIG. 23 is described next according to the step numbers in the flowchart.

(Step S31) The category notification generating unit 271 generates a category notification indicating a category of the mobile station (for example, a category identifier). The wireless transmitting unit 275 transmits the generated category notification by the PUSCH.

(Step S32) The wireless receiving unit 220 receives MBSFN service information from the base station 100 by the PMCH (MCCH). The MBSFN control information extracting unit 243 extracts the MBSFN service information.

(Step S33) The MBSFN control unit 251 selects an MBMS service based on the MBSFN service information received in step S32 and a user's operation. The MBSFN request generating unit 272 generates an MBSFN request indicating the selected MBMS service. The wireless transmitting unit 275 transmits the generated MBSFN request to the base station 100 by the PUSCH.

(Step S34) The wireless receiving unit 220 receives reception control information from the base station 100 by the PDCCH. The reception control information extracting unit 242 extracts the reception control information. Based on the reception control information, the terminal control unit 260 determines whether the mobile station is capable of receiving both MBMS data and dedicated data. If the determination is affirmative, the process moves to step S35. If the determination is negative, the process moves to step S38.

(Step S35) Based on capability information stored in the capability information storing unit 253, the terminal control unit 260 determines whether the mobile station is capable of concurrently receiving the normal and the extended cyclic prefixes. If the determination is affirmative, the process moves to step S36. If the determination is negative, the process moves to step S37.

(Step S36) Using the two receiving systems of the demodulation and decoding unit 230, the terminal control unit 260 configures settings for concurrent reception of MBMS data and dedicated data.

(Step S37) The terminal control unit 260 configures settings for time division reception of MBMS data and dedicated data.

(Step S38) The terminal control unit 260 configures settings for receiving dedicated data transmitted by the base station 100 but not receiving MBMS data sent by MBSFN transmission.

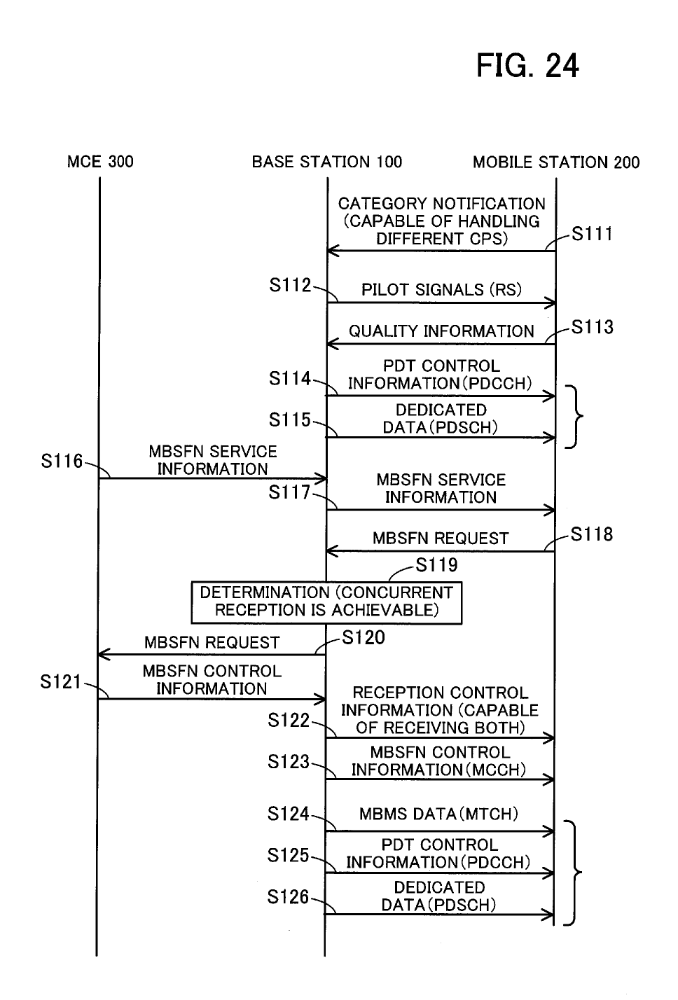

FIG. 24 is a first sequence diagram illustrating an example of data transmission control. The first sequence example represents a case where the mobile station 200 concurrently receives MBMS data and dedicated data.

The mobile station 200 transmits, to the base station 100, a category notification indicating that the mobile station 200 is capable of handling in parallel cyclic prefixes of different lengths (step S111). The base station 100 transmits a downlink wireless frame including reference signals, which are pilot signals (step S112). The mobile station 200 measures received quality using the reference signals transmitted by the base station 100 and transmits quality information, such as a CQI, to the base station 100 (step S113). The base station 100 schedules transmission of dedicated data directed to the mobile station 200, and then transmits, to the mobile station 200, the PDT control information by the PDCCH and the dedicated data by the PDSCH (steps S114 and S115).

The MCE 300 transmits, to the base station 100, MBSFN service information which is a list of MBMS services (step S116). The base station 100 transmits the MBSFN service information by the MCCH mapped in the PMCH (step S117). The mobile station 200 selects a desired MBMS service and transmits an MBSFN request to the base station 100 (step S118). Based on the category of the mobile station 200, the station 100 determines that the mobile station 200 is capable of concurrently receiving MBMS data and dedicated data (step S119).

The base station 100 transfers the MBSFN request to the MCE 300 (step S120). The MCE 300 transmits, to the base station 100, MBSFN control information indicating, for example, a transmission timing of MBMS data (step S121). The base station 100 transmits, to the mobile station 200, reception control information indicating that the mobile station 200 is capable of receiving both MBMS data and dedicated data (step S122). The base station 100 transmits, to the mobile station 200, the MBSFN control information by the MCCH mapped in the PMCH (step S123).

The base station 100 transmits MBMS data received from the MBMS gateway 420, by the MTCH mapped in the PMCH (step S124). At the same timing as the transmission of the MBMS data, the base station 100 transmits, to the mobile station 200, PDT control information by the PDCCH and dedicated data, received from the SAE gateway 430, by the PDSCH (steps S125 and S126). Referring to the MBSFN control information, the mobile station 200 extracts the MBMS data. In parallel to the extraction of the MBMS data, the mobile station 200 extracts the dedicated data by referring to the PDT control information.

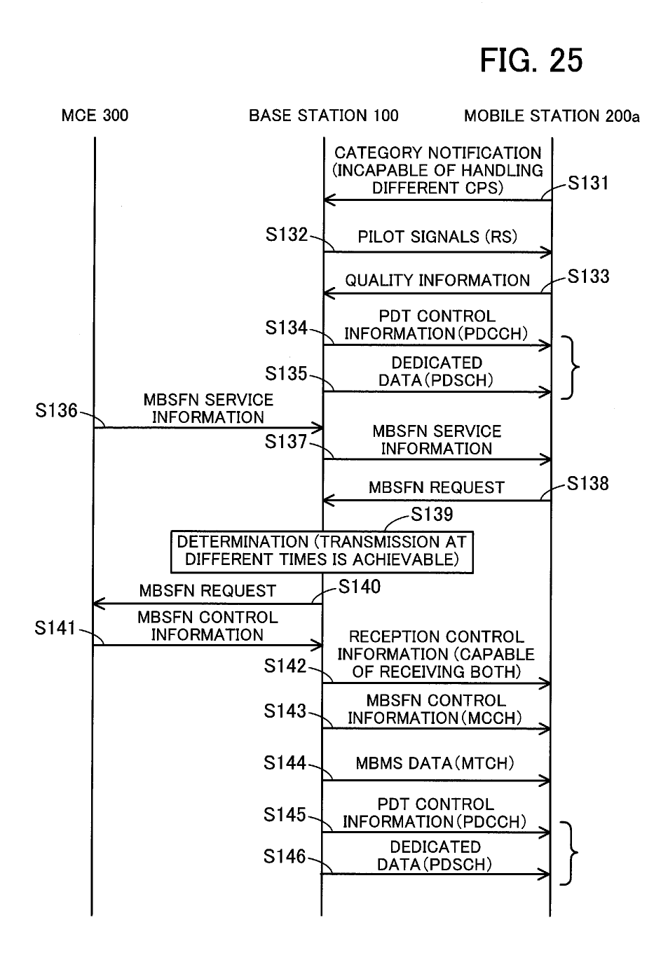

FIG. 25 is a second sequence diagram illustrating an example of data transmission control. The second sequence example represents a case where the mobile station 200a receives MBMS data and dedicated data using a time division technique.

The mobile station 200a transmits, to the base station 100, a category notification indicating that the mobile station 200a is incapable of handling in parallel cyclic prefixes of different lengths (step S131). The operations of steps S132 through S138 are the same as those of steps S112 through S118 of FIG. 24. Based on the category of the mobile station 200a, the base station 100 determines that the mobile station 200a is incapable of concurrently receiving MBMS data and dedicated data. Further, the base station 100 calculates an achievable transmission rate of the dedicated data. Assume here that the base station 100 determines that the achievable transmission rate meets a needed transmission rate without concurrently transmitting the dedicated data with MBMS data (step S139).

The operations of steps S140 through S143 are the same as those of steps S120 through S123 of FIG. 24. The base station 100 transmits MBMS data received from the MBMS gateway 420, by the MTCH mapped in the PMCH (step S144). At a different timing from the transmission of the MBMS data, the base station 100 transmits, to the mobile station 200a, PDT control information by the PDCCH and dedicated data, received from the SAE gateway 430, by the PDSCH (steps S145 and S146). The mobile station 200a extracts the MBMS data by referring to the MBSFN control information and extracts the dedicated data by referring to the PDT control information at different times.

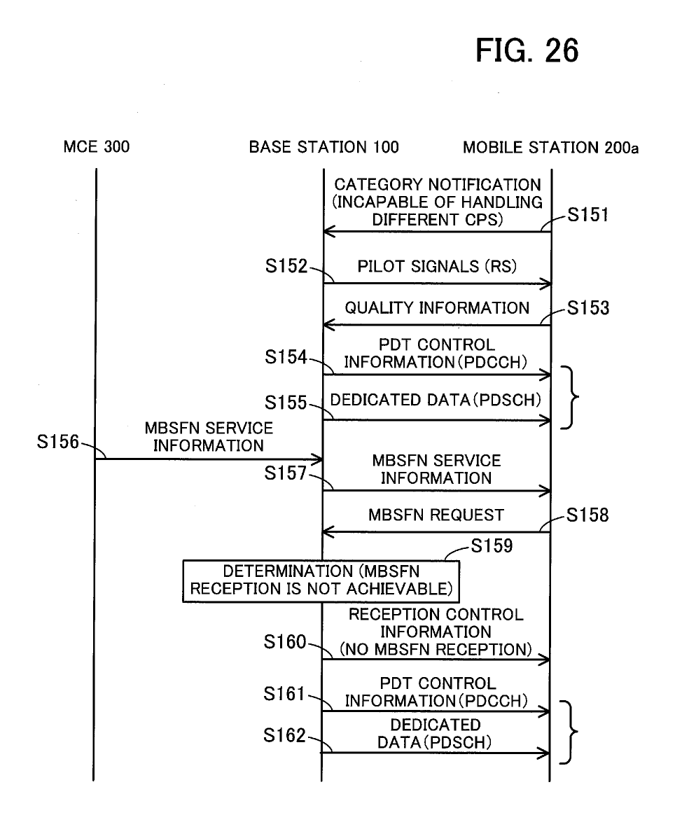

FIG. 26 is a third sequence diagram illustrating an example of data transmission control. The third sequence example represents a case where the mobile station 200a does not receive MBMS data.

The mobile station 200a transmits, to the base station 100, a category notification indicating that the mobile station 200a is incapable of handling in parallel cyclic prefixes of different lengths (step S151). The operations of steps S152 through S158 are the same as those of steps S112 through S118 of FIG. 24. Based on the category of the mobile station 200a, the base station 100 determines that the mobile station 200a is incapable of concurrently receiving MBMS data and dedicated data. Further, the base station 100 calculates an achievable transmission rate of the dedicated data. Assume here that the base station 100 determines that the achievable transmission rate does not meet a needed transmission rate without concurrently transmitting the dedicated data with MBMS data (step S159).

The base station 100 transmits, to the mobile station 200a, reception control information indicating that the mobile station 200a is not able to receive MBMS data sent by MBSFN transmission (step S160). At the same timing as the transmission of MBMS data, the base station 100 transmits, to the mobile station 200a, PDT control information by the PDCCH and dedicated data, received from the SAE gateway 430, by the PDSCH (steps S161 and S162). The mobile station 200a receives the dedicated data while not receiving the MBMS data.

In the case of being notified of the incapability of receiving MBMS data, the mobile station 200a may start receiving MBMS data after the transmission of the dedicated data at the needed transmission rate is finished or after the needed transmission rate is reduced. When the reception of MBMS data becomes possible, the base station 100 may notify the mobile station 200a accordingly. FIGS. 24 through 26 illustrate cases where the mobile station 200/200a makes an MBSFN request during reception of dedicated data. However, the base station 100 may exercise similar control also when the mobile station 200/200a starts reception of dedicated data at a specified needed rate during reception of MBMS data. In addition, the base station 100 may transmit, to the mobile station 200a as the reception control information, information indicating that the mobile station 200a is capable of receiving not MBMS data but only dedicated data.

In FIGS. 24 through 26, the base station 100 transmits reception control information to the mobile station 200/200a in response to a request of the mobile station 200/200a. However, the reception control information may be transmitted to the mobile station 200/200a in advance, without such a request.

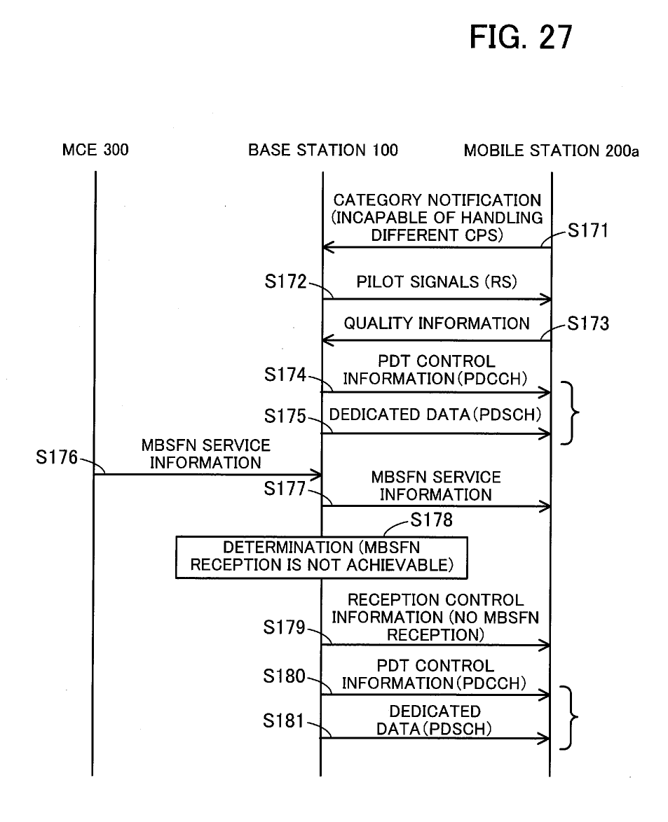

FIG. 27 is a fourth sequence diagram illustrating an example of data transmission control. The fourth sequence example represents a case where the mobile station 200a does not receive MBMS data, as in FIG. 26.

The mobile station 200a transmits, to the base station 100, a category notification indicating that the mobile station 200a is incapable of handling in parallel cyclic prefixes of different lengths (step S171). The operations of steps S172 through S177 are the same as those of steps S112 through S117 of FIG. 24. If the mobile station 200a is in the middle of receiving dedicated data at a specified needed rate, the base station 100 determines whether the mobile station 200a is capable of receiving both the dedicated data and MBMS data, regardless of the presence or absence of an MBSFN request (step S178).

In the case where the mobile station 200a is incapable of concurrently receiving both dedicated data and MBMS data, the base station 100 transmits in advance, to the mobile station 200a, reception control information indicating that the mobile station 200a is not able to receive MBMS data sent by MBSFN transmission (step S179). In response to the reception control information, the mobile station 200a prohibits transmission of an MBSFN request until the reception of the dedicated data at the specified needed rate is finished or until the specified needed rate is reduced. The base station 100 transmits, to the mobile station 200a, PDT control information by the PDCCH and dedicated data, received from the SAE gateway 430, by the PDSCH (steps S180 and S181).

With the mobile communication system according to the second embodiment described above, dedicated data directed to the mobile station 200 capable of handling in parallel cyclic prefixes of different lengths is concurrently transmitted with MBMS data. This results in an effective use of wireless resources of multiple component carriers. On the other hand, as for dedicated data directed to the mobile station 200a incapable of handling in parallel cyclic prefixes of different lengths, the transmission is scheduled to be at a different time from the transmission of MBMS data. This avoids wasteful data transmission. In the case where it is not possible to transmit the dedicated data at a different time from the transmission of MBMS data, the base station 100 instructs the mobile station 200a to preferentially receive the dedicated data and not to receive MBMS data. This reduces the burden associated with the reception processes upon the mobile station 200a.

### Third Embodiment

A third embodiment is described next. While omitting repeated explanations, the following description focuses on differences from the above-described second embodiment. A mobile communication system of the third embodiment differs from that of the second embodiment in the method of notifying a mobile station that the mobile station is not able to receive MBMS data.

The mobile communication system of the third embodiment may be achieved using the same system configuration as that of the mobile communication system of the second embodiment illustrated in FIG. 2. In addition, a mobile station of the third embodiment is implemented using the same block architecture as the mobile station 200/200a.

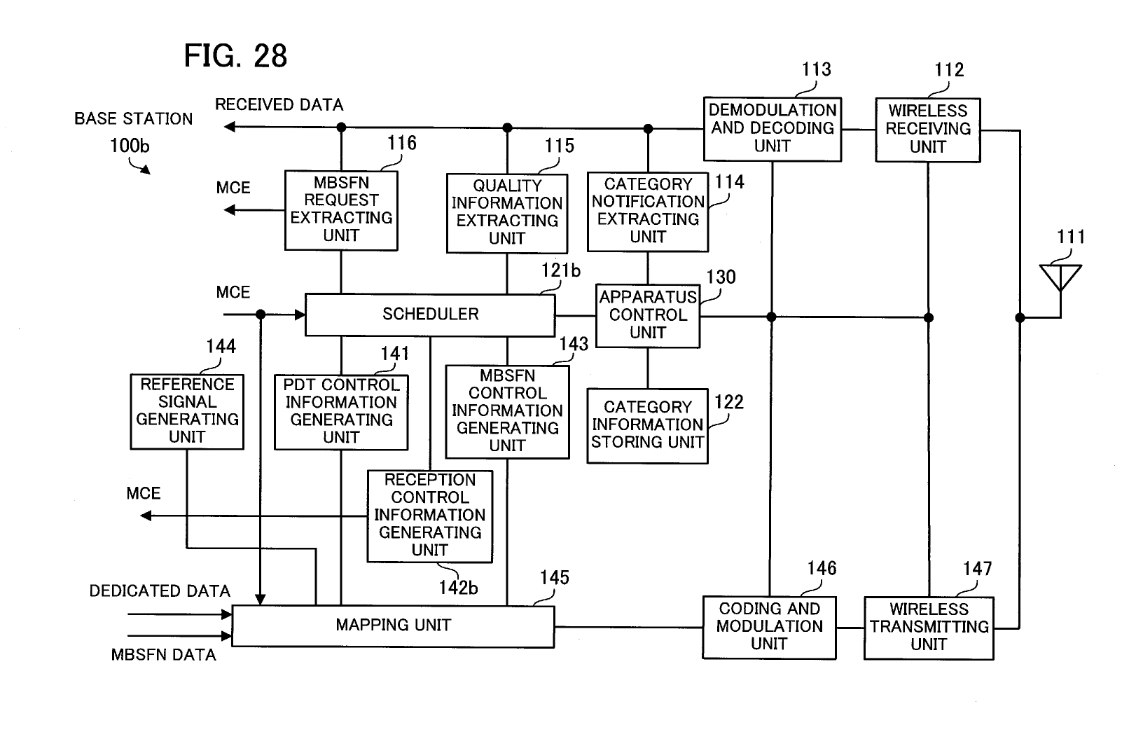

FIG. 28 is a block diagram of a base station according to the third embodiment. A base station 100b includes the antenna 111; the wireless receiving unit 112; the demodulation and decoding unit 113; the category notification extracting unit 114; the quality information extracting unit 115; the MBSFN request extracting unit 116; a scheduler 121b; the category information storing unit 122; the apparatus control unit 130; the PDT control information generating unit 141; a reception control information generating unit 142b; the MBSFN control information generating unit 143; the reference signal generating unit 144; the mapping unit 145; the coding and modulation unit 146; and the wireless transmitting unit 147.

When the MBSFN request extracting unit 116 extracts an MBSFN request, the scheduler 121b determines whether a requesting mobile station is capable of receiving MBMS data in addition to dedicated data, based on the category and the like of the requesting mobile station. If the determination is negative, the scheduler 121b instructs the reception control information generating unit 142b to transmit an MBSFN rejection notification to an MCE 300a (to be described later). The MBSFN rejection notification indicates that the received MBSFN request is rejected. In response to the instruction of the scheduler 121b, the reception control information generating unit 142b generates the MBSFN rejection notification and transmits the generated notification to the MCE 300a.

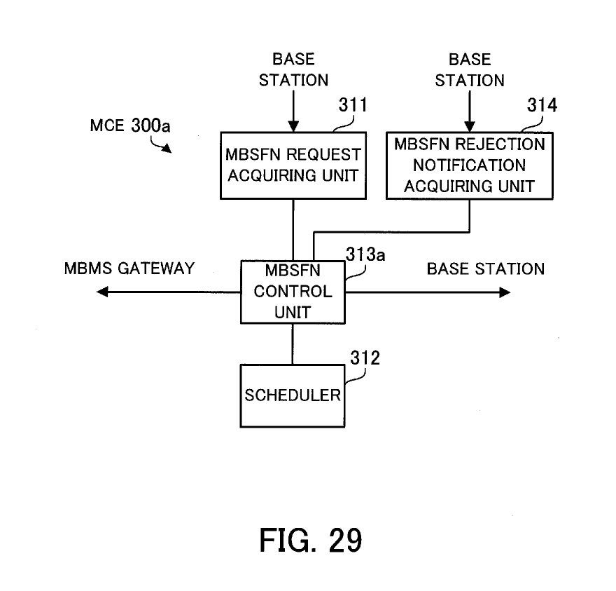

FIG. 29 is a block diagram of an MCE according to the third embodiment. The MCE 300a includes the MBSFN request acquiring unit 311; the scheduler 312; an MBSFN control unit 313a; and an MBSFN rejection notification acquiring unit 314.

The MBSFN rejection notification acquiring unit 314 receives an MBSFN rejection notification from the base station 100b and outputs the MBSFN rejection notification to the MBSFN control unit 313a. On acquiring the MBSFN rejection notification, the MBSFN control unit 313a transmits, to the mobile station 200/200a via the base station 100b, reception control information indicating that an MBMS service requested by the mobile station 200/200a is not available for the mobile station 200/200a.

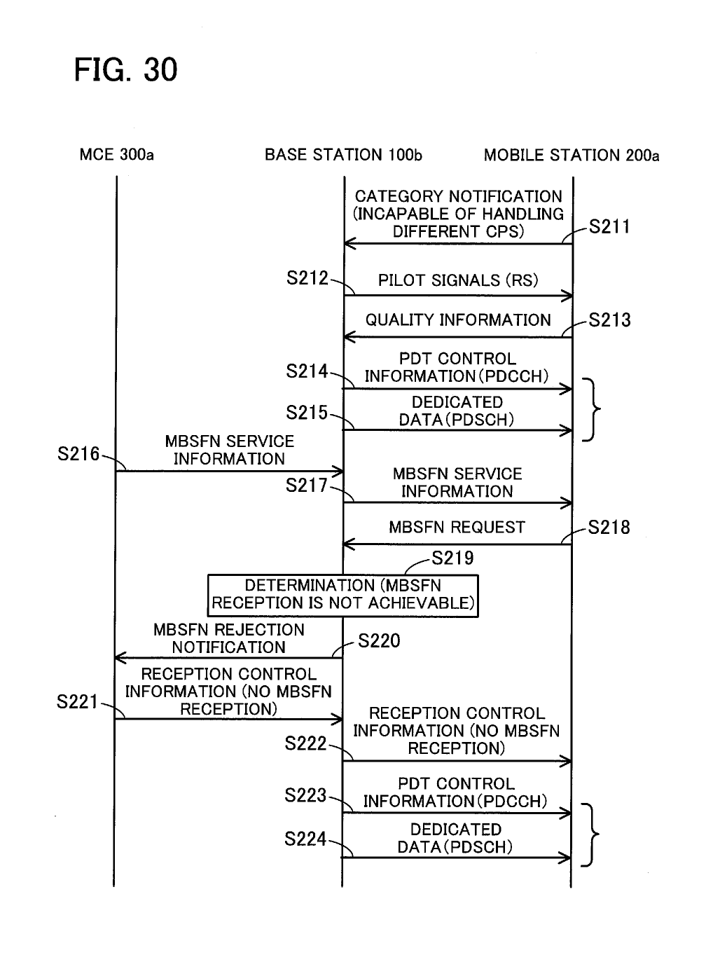

FIG. 30 is a fifth sequence diagram illustrating an example of data transmission control. The fifth sequence example represents a case where the mobile station 200a does not receive MBMS data.

The mobile station 200a transmits, to the base station 100b, a category notification indicating that the mobile station 200a is incapable of handling in parallel cyclic prefixes of different lengths (step S211). The operations of steps S212 through S218 are the same as those of steps S112 through S118 described in the second embodiment. Based on the category of the mobile station 200a, the base station 100b determines that the mobile station 200a is incapable of concurrently receiving MBMS data and dedicated data. Further, the base station 100b calculates an achievable transmission rate of the dedicated data. Assume here that the base station 100b determines that the achievable transmission rate does not meet a needed transmission rate without concurrently transmitting the dedicated data with MBMS data (step S219).

The base station 100b transmits, to the MCE 300a, an MBSFN rejection notification including information that indicates a requested MBMS service (step S220). Then, the MCE 300a transmits, to the base station 100b, reception control information indicating that the MBSFN request is rejected (step S221). The base station 100b transfers, to the mobile station 200a, the reception control information received from the MCE 300a (step S222). At the same timing as the transmission of the MBMS data, the base station 100b transmits, to the mobile station 200a, PDT control information by the PDCCH and dedicated data, received from the SAE gateway 430, by the PDSCH (steps S223 and S224). The mobile station 200a receives the dedicated data while not receiving the MBMS data.

According to such a mobile communication system of the third embodiment, the same effect as in the second embodiment may be achieved. In addition, the MCE 300a is able to manage, in an integrated fashion, the situation of MBSFN requests transmitted by the mobile stations 200 and 200a and acceptance or rejection of each of the MBSFN requests.

The above-described wireless communication apparatus, wireless communication system, and wireless communication method allow efficient wireless communication using multiple frequency bands.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A wireless communication apparatus for communicating with another wireless communication apparatus, using a plurality of frequency bands, the wireless communication apparatus comprising:
a transmitting unit configured to transmit first data with first-length guard intervals in a first frequency band selected from among the plurality of frequency bands, and transmit second data with second-length guard intervals in a second frequency band selected from among the plurality of frequency bands; and
a control unit configured to acquire, from the other wireless communication apparatus, capability information on capability of the other wireless communication apparatus to handle in parallel the first-length guard intervals and the second-length guard intervals, and schedule transmission of at least one of the first data and the second data based on the capability information.

2. The wireless communication apparatus according to claim 1, wherein when the capability information indicates that the other wireless communication apparatus is incapable of handling in parallel the first-length guard intervals and the second-length guard intervals, the control unit controls the first data and the second data to be transmitted at different times.

3. The wireless communication apparatus according to claim 1, wherein a plurality of other wireless communication apparatuses including the other wireless communication apparatus are classified into a plurality of categories according to one or more capability-related aspects including the capability of handling in parallel the first-length guard intervals and the second-length guard intervals, and
the control unit acquires, as the capability information, information indicating a category of the other wireless communication apparatus, and schedules the transmission based on the category of the other wireless communication apparatus.

4. The wireless communication apparatus according to claim 1, wherein the first data is receivable by the plurality of other wireless communication apparatuses including the other wireless communication apparatus, and the second data is specifically directed to the other wireless communication apparatus, and
the control unit schedules the transmission of the second data.

5. A wireless communication apparatus for communicating with another wireless communication apparatus, using a plurality of frequency bands, the wireless communication apparatus comprising:
a receiving unit configured to receive first data with first-length guard intervals and second data with second-length guard intervals in parallel or at different times, the first data with the first-length guard intervals being transmitted in a first frequency band selected from among the plurality of frequency bands and the second data with the second-length guard intervals being transmitted in a second frequency band selected from among the plurality of frequency bands; and
a notifying unit configured to notify the other wireless communication apparatus of capability information before the reception of the first data and the second data, the capability information indicating capability of the wireless communication apparatus to handle in parallel the first-length guard intervals and the second-length guard intervals.

6. A wireless communication system for communicating using a plurality of frequency bands, the wireless communication system comprising:
a first wireless communication apparatus including a notifying unit which makes a notification of capability information on capability of the first wireless communication apparatus to handle in parallel first-length guard intervals and second-length guard intervals; and
a second wireless communication apparatus including
a transmitting unit which transmits first data with the first-length guard intervals in a first frequency band selected from among the plurality of frequency bands, and transmits second data with the second-length guard intervals in a second frequency band selected from among the plurality of frequency bands, and
a control unit which schedules transmission of at least one of the first data and the second data based on the capability information.

7. A wireless communication method for a wireless communication system in which a first wireless communication apparatus and a second wireless communication apparatus communicate with each other using a plurality of frequency bands, the wireless communication method comprising:
notifying, by the first wireless communication apparatus, the second wireless communication apparatus of capability information on capability of the first wireless communication apparatus to handle in parallel first-length guard intervals and second-length guard intervals;
scheduling, by the second wireless communication apparatus, transmission of at least one of first data with the first-length guard intervals and second data with the second-length guard intervals, based on the capability information; and
transmitting, by the second wireless communication apparatus, the first data in a first frequency band selected from among the plurality of frequency bands and the second data in a second frequency band selected from among the plurality of frequency bands in parallel or at different times according to a result of the scheduling.
